(19) United States
(12) Patent Application Publication
(10) Pub. No.: US 2026/0335771 A1
(43) Pub. Date: Oct. 29, 2026

(54) VIRTUAL CHARACTER LEVEL ADJUSTMENT

(71) Applicant: TENCENT TECHNOLOGY (SHENZHEN) COMPANY LIMITED, Shenzhen (CN)

(72) Inventors: Yuxuan LU, Shenzhen (CN); Yanan ZHANG, Shenzhen (CN)

(73) Assignee: TENCENT TECHNOLOGY (SHENZHEN) COMPANY LIMITED, Shenzhen (CN)

(21) Appl. No.: 19/713,329

(22) Filed: Jun. 18, 2026

Related U.S. Application Data
(63) Continuation of application No. PCT/CN2025/075317, filed on Jan. 26, 2025.

(30) Foreign Application Priority Data
Feb. 8, 2024 (CN) 202410178221.1

(51) Int. Cl. A63F 13/69; A63F 13/53

(52) U.S. Cl. CPC A63F 13/69; A63F 13/53

(57) ABSTRACT

In a virtual character level adjustment method, a battle interface including a hand region and a board region is displayed. A piece card is displayed in the hand region. The piece card is used to generate a virtual character in the board region when the virtual character is not in the board region or to adjust a level of the virtual character when the virtual character is in the board region. In response to an operation on the piece card, a level identifier of the virtual character is modified based on level information of the virtual character and an energy value of the piece card. The level information indicates an initial level and a level progression rate of the virtual character. The energy value indicates a quantity of energy required to use the piece card.

### RELATED APPLICATIONS

The present application is a continuation of International Application No. PCT/CN2025/075317, filed on Jan. 26, 2025, which claims priority to Chinese Patent Application No. 202410178221.1, filed on Feb. 8, 2024. The entire disclosures of the prior applications are hereby incorporated by reference.

### FIELD OF THE TECHNOLOGY

Embodiments of this disclosure relate to the field of computer technologies, including a virtual character level adjustment method and apparatus, a terminal, and a storage medium.

### BACKGROUND

In an auto chess game, a same virtual character (that is, a piece) has different star levels (or levels), and the virtual character has different strength at different star levels.

In related art, each virtual character is one-star, two-star, or three-star, and a star level of a virtual character is in positive correlation with strength of the virtual character. For each virtual character, every three virtual characters of a same star level may be synthesized into a virtual character of a next star level. For example, every three one-star virtual characters may be synthesized into a two-star virtual character.

However, in related art, for each virtual character, a user needs to collect a specified quantity of virtual characters of a same star level for synthesis into a virtual character of a next star level (that is, strength), which is not so convenient to upgrade virtual characters.

### SUMMARY

Aspects of this disclosure include a virtual character level adjustment method and apparatus, a terminal, and a storage medium. Technical solutions provided in the aspects of this disclosure may include the following content.

According to an aspect of this disclosure, a virtual character level adjustment method is provided. In the method, a battle interface of a turn-based board game is displayed. The battle interface includes a hand region and a board region. A piece card is displayed in the hand region. The piece card is used to generate a virtual character in the board region when the virtual character is not in the board region or adjust a level of the virtual character when the virtual character is in the board region. In response to an operation on the piece card, a level identifier of the virtual character in the board region is modified from a first level identifier to a second level identifier based on level information of the virtual character and an energy value of the piece card. The level information indicates an initial level and a level progression rate of the virtual character. The energy value indicates a quantity of energy required to use the piece card.

According to an aspect of this disclosure, a virtual character level adjustment apparatus is provided. The apparatus includes processing circuitry configured to display a battle interface of a turn-based board game. The battle interface includes a hand region and a board region. The processing circuitry is configured to display a piece card in the hand region. The piece card is used to generate a virtual character in the board region when the virtual character is not in the board region or adjust a level of the virtual character when the virtual character is in the board region. The processing circuitry is configured to modify, in response to an operation on the piece card, a level identifier of the virtual character in the board region from a first level identifier to a second level identifier based on level information of the virtual character and an energy value of the piece card. The level information indicates an initial level and a level progression rate of the virtual character. The energy value indicates a quantity of energy required to use the piece card.

According to an aspect of this disclosure, a non-transitory computer-readable storage medium is provided. The non-transitory computer-readable storage medium stores instructions, which when executed by a processor, cause the processor to implement a virtual character level adjustment method. In the method, a battle interface of a turn-based board game is displayed. The battle interface includes a hand region and a board region. A piece card is displayed in the hand region. The piece card is used to generate a virtual character in the board region when the virtual character is not in the board region or adjust a level of the virtual character when the virtual character is in the board region. In response to an operation on the piece card, a level identifier of the virtual character in the board region is modified from a first level identifier to a second level identifier based on level information of the virtual character and an energy value of the piece card. The level information indicates an initial level and a level progression rate of the virtual character. The energy value indicates a quantity of energy required to use the piece card.

According to an aspect of this disclosure, a virtual character level adjustment method is provided. The method is performed by a terminal device. The method includes: displaying a battle interface of a turn-based board game, the battle interface including a hand region and a board region, the hand region being configured for displaying a card, and the board region being configured for displaying a virtual character; displaying a first piece card in the hand region, the first piece card being configured for adding a first virtual character to the board region or adjusting a level of a first virtual character already existing in the board region; and modifying, in response to an operation for using the first piece card, a level identifier of the first virtual character displayed in the board region from a first level identifier to a second level identifier when the first virtual character already exists in the board region, a level indicated by the first level identifier being different from a level indicated by the second level identifier.

According to an aspect of this disclosure, a virtual character level adjustment apparatus is provided. The apparatus includes: a battle interface display module, configured to display a battle interface of a turn-based board game, the battle interface including a hand region and a board region, the hand region being configured for displaying a card, and the board region being configured for displaying a virtual character; a piece card display module, configured to display a first piece card in the hand region, the first piece card being configured for adding a first virtual character to the board region or adjusting a level of a first virtual character already existing in the board region; and a level identifier adjustment module, configured to modify, in response to an operation for using the first piece card, a level identifier of the first virtual character displayed in the board region from a first level identifier to a second level identifier when the first virtual character already exists in the board region, a level indicated by the first level identifier being different from a level indicated by the second level identifier.

According to an aspect of this disclosure, a terminal device is provided. The terminal device includes a processor (an example of processing circuitry) and a memory. The memory has a computer program stored therein. The computer program is loaded and executed by the processor to implement the foregoing virtual character level adjustment method.

According to an aspect of this disclosure, a computer-readable storage medium (e.g., a non-transitory computer-readable storage medium) is provided. The computer-readable storage medium has a computer program stored therein. The computer program is loaded and executed by a processor to implement the foregoing virtual character level adjustment method.

According to an aspect of this disclosure, a computer program product is provided. The computer program product includes a computer program. The computer program is stored in a computer-readable storage medium. A processor of a terminal device reads the computer program from the computer-readable storage medium. The processor executes the computer program, so that the terminal device performs the foregoing virtual character level adjustment method.

The technical solutions provided in the aspects of this disclosure may include the following beneficial effects.

When the first virtual character already exists in the board region corresponding to the turn-based board game, each first piece card corresponding to the first virtual character may be configured for adjusting a level of the first virtual character, so that a user can adjust the level of the first virtual character only by using any first piece card, without collecting a plurality of first piece cards that satisfy a preset condition and that correspond to the first virtual character, improving convenience of adjusting the level of the first virtual character. In addition, time consumed in accumulating piece cards is shortened, so that level stagnation duration of the first virtual character is shortened, helping improve coherence of level adjustment of the first virtual character.

In addition, compared with related art in which operations need to be performed on the plurality of first piece cards, in the aspects of this disclosure, the level of the first virtual character can be adjusted through only one operation. This helps improve human-computer interaction efficiency and further improve the convenience of adjusting the level of the first virtual character.

### BRIEF DESCRIPTION OF THE DRAWINGS

FIG. 1 is a schematic diagram of a computer system according to an aspect of this disclosure.

FIG. 2 is a flowchart of a battle interaction method for a turn-based board game according to an aspect of this disclosure.

FIG. 3 is a schematic diagram of a battle interface according to an aspect of this disclosure.

FIG. 4 is a schematic diagram of a piece card according to an aspect of this disclosure.

FIG. 5 is a schematic diagram of an effect card according to an aspect of this disclosure.

FIG. 6 is a schematic diagram of an equipment card according to an aspect of this disclosure.

FIG. 7 is a schematic diagram of a chess player card according to an aspect of this disclosure.

FIG. 8 is a flowchart of a battle interaction method for a turn-based board game according to another aspect of this disclosure.

FIG. 9 is a schematic diagram of a chess player selection interface according to an aspect of this disclosure.

FIG. 10 is a schematic diagram of a quality identifier according to an aspect of this disclosure.

FIG. 11 is a schematic diagram of an example of an automatic melee combat between an own piece and an opponent piece in a board region.

FIG. 12 is a schematic diagram of a settlement animation effect according to an aspect of this disclosure.

FIG. 13 is a schematic diagram of a settlement interface according to an aspect of this disclosure.

FIG. 14 is a flowchart of a virtual character level adjustment method according to an aspect of this disclosure.

FIG. 15 is a schematic diagram of increasing a level of a virtual character according to an aspect of this disclosure.

FIG. 16 is a schematic diagram of a change in base strength under different quality over time according to an aspect of this disclosure.

FIG. 17 is a diagram of differences between sizes of models at different levels according to an aspect of this disclosure.

FIG. 18 is a schematic diagram of a lineup region according to an aspect of this disclosure.

FIG. 19 is a schematic diagram of a method for determining a level of a deployed virtual character according to an aspect of this disclosure.

FIG. 20 is a block diagram of a virtual character level adjustment apparatus according to an aspect of this disclosure.

FIG. 21 is a block diagram of a virtual character level adjustment apparatus according to another aspect of this disclosure.

FIG. 22 is a block diagram of a structure of a terminal device according to an aspect of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

In the following description, the use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In the following description, “a plurality of” means two or more. The term “and/or” describes an association relationship between associated objects and represents that three relationships may exist. For example, A and/or B may represent the following three cases:

Only A exists, both A and B exist, and only B exists. The character “/” generally indicates an “or” relationship between the associated objects. In addition, the operation numbers described in this specification merely show a possible execution sequence of the operations as an example. In some other aspects, the foregoing operations may not be performed based on the number sequence. For example, two operations with different numbers may be performed simultaneously, or two operations with different numbers may be performed based on a sequence contrary to the sequence shown in the figure. This is not limited in the disclosure.

In the following description, terms such as “first” and “second” are intended to distinguish between similar objects but do not necessarily indicate a specific order or sequence. Data used in this way may be interchanged in a proper circumstance, so that aspects of this disclosure described herein can be implemented in a sequence different from those shown in the drawings or described herein. In addition, terms “include”, “have”, and any variants thereof are intended to cover a non-exclusive inclusion, for example, a process, method, system, product, or device that includes a series of steps or units is not necessarily limited to the steps or units specified expressly, but may include other steps or units not specified expressly or may include steps or units inherent to the process, method, product or device.

Examples of terms involved in the aspects of the disclosure are briefly introduced. The descriptions of the terms are provided as examples only and are not intended to limit the scope of the disclosure.

Turn-based board game: is a board game in which “pieces” are pre-arranged before a battle and the “pieces” can automatically battle against each other in a battle process based on the pre-arrangement. The “piece” can be represented by a virtual character, and for example, may be referred to as a virtual hero. In the battle process, the virtual character automatically casts various skills for the battle. The battle can be turn-based. When all “pieces” of a battle side are defeated (that is, health values of virtual characters decrease to zero), this side is a losing side of this battle turn. In some aspects, in addition to having “piece type virtual characters” for the battle, both sides of the battle further deploy a chess player character to represent a current user participating in the battle, and the chess player character cannot be moved as a “piece” to a battle region or a piece candidate region. A health value (or hit points) is also set for the chess player character. Based on a result of each battle, the health value of the chess player character correspondingly decreases (losing in the battle), remains unchanged (winning in the battle), or increases. When the health value of the chess player character decreases to zero, the user corresponding to the chess player character exits the battle, and remaining users continue to perform the battle. In some aspects, the turn-based board game includes an auto chess game, an auto chess for short.

Auto chess game: is a multiplayer turn-based competitive game that supports in-game collection and replacement of hero pieces. For example, there are eight or six players in total in a game, and the players each occupy a region on a board. Two of a plurality of players perform a one-to-one battle. Each turn of a battle includes two phases: a battle preparation phase and a battle phase. In the battle preparation phase, users purchase pieces (heroes) in a shop and deploy lineups on the board. In the battle phase, the lineups of the two sides are locked, and the pieces are automatically engaged until all the pieces of one side are defeated. The side whose pieces are all defeated is a losing side of the current turn, and specific hit points of the side are deducted. Game turns are continuously repeated, with new opponents being matched. A player (that is, the foregoing player character) is eliminated when a health value of the player is less than or equal to 0. Only one player remains at last, and wins the game (rank 1).

Board: is a region in a battle interface of a turn-based board game that is configured for preparing a battle and performing the battle. For example, the board may be any one of a two-dimensional virtual board, a 2.5-dimensional virtual board, and a three-dimensional virtual board. This is not limited in this disclosure.

A board of a related auto chess game is divided into a battle region and a piece candidate region. The battle region includes a plurality of tiles of a same size, and the tiles are configured for placing pieces for battling in a battle process. The piece candidate region includes a plurality of candidate piece locations, and the candidate piece locations are configured for placing candidate pieces. The candidate pieces do not participate in battling in the battle process, and can be dragged and placed in the battle region in a battle preparation phase. A board region provided in this disclosure does not include a piece candidate region, and includes only a battle region.

Regarding a manner of arranging tiles in the battle region, in some aspects, the battle region includes n (rows)× m (columns) tiles. For example, n is an integer multiple of 2, and two adjacent rows of tiles are aligned, or two adjacent rows of tiles are staggered. In addition, the battle region is evenly divided into two parts by rows: an own battle region and an opponent battle region. Users participating in the battle are respectively located on an upper side and a lower side of the battle interface, and in the battle preparation phase, the users can place pieces only in their own battle regions. In some other aspects, the battle region is evenly divided into two parts by columns: an own battle region and an opponent battle region, and users participating in the battle are respectively located on a left side and a right side or an upper side and a lower side of the battle interface. A shape of the tile may be any one of a square, a rectangle, a circle, and a hexagon. The shape of the tile is not limited in this disclosure. In some aspects, each side of the battle corresponds to a board (that is, the entire board is a battle region), and in the battle phase, a game system splices the boards of both sides of the battle, to implement the battle between the two sides.

Card game: is a common term of a game type, and originates from a board game. Unlike a chess game in which piece models are directly controlled, the card game carries in-game content on cards. Compared with pieces, the cards are more convenient for carrying some text descriptions, card attribute information, and transmission of some key values. “Cardification” means converting a virtual character resource into a card resource, so that a player can read and classify a card effect, and information transmission in more dimensions can be carried.

Energy: is a resource manner of a game. However, in this disclosure, energy is defined as a virtual resource for a player to play a card. When a card is played, energy of a corresponding value marked on the card needs to be consumed, and the consumed energy is a cost corresponding to the card. A cost of the card can be referred to as an energy value of the card.

Equipment: In an auto chess game, each piece may generally be equipped with three pieces of equipment (or another quantity of pieces of equipment). The equipment may provide a virtual character with attributes or effects such as attack power, defense power, a health value, treatment, penetration, and a shield. An auto chess game in related art for example has a jungle phase, and after defeating a monster, a player obtains equipment that the monster drops. Component equipment may be synthesized into equipment of higher quality.

Chess player character: is a virtual character played by a player. Each chess player character has a different special capability (that is, a chess player skill), which can help the player play a game better.

Base strength of a virtual character: is a base attribute of the virtual character. The base attribute is configured for indicating an initial state of an attribute. A real attribute corresponding to the virtual character may be adjusted based on the initial value by using equipment, an effect, a skill, or the like. The base attribute includes at least one of the following: base combat power, base defense power, a base health value, a base armor, and base spell power. The base attribute of the virtual character may be viewed by using a battle interface (for example, for a trigger operation on a card or a virtual character, a base attribute of the virtual character at a current level may be viewed).

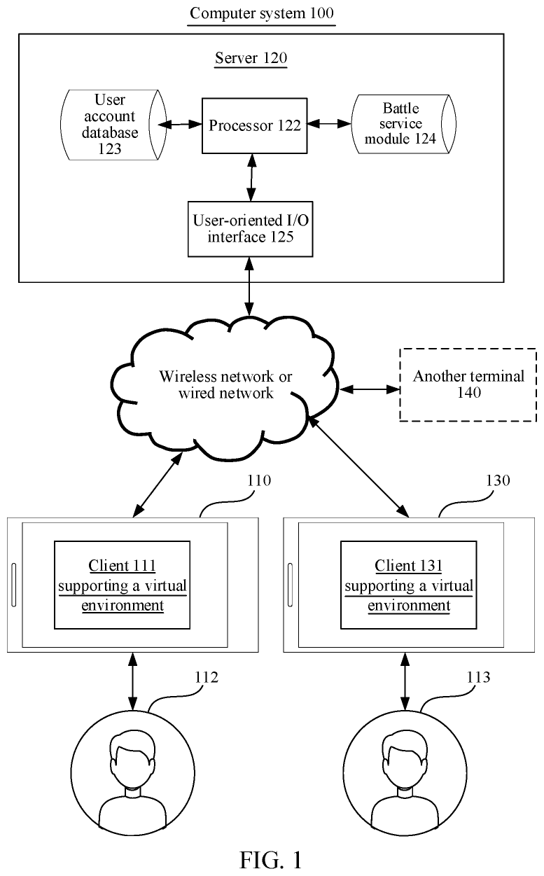

FIG. 1 is a block diagram of a structure of a computer system according to an aspect of this disclosure. The computer system 100 may be implemented as a solution implementation environment of an aspect of this disclosure. The computer system 100 may include a first terminal 110, a server 120, and a second terminal 130.

A client 111 supporting a virtual environment is installed and run on the first terminal 110. The client 111 may be a client of a turn-based board game program. When the first terminal runs the client 111, a user interface (for example, the foregoing battle interface) of the client 111 is displayed on a screen of the first terminal 110. The client may be a client of an auto chess game. The first terminal 110 is a terminal used by a first user 112. In a battle preparation phase of a battle, the first user 112 may use the first terminal 110 to arrange a piece in a battle region in the battle interface, and the first terminal 110 or the server 120 automatically controls the piece for battling in a battle phase based on an attribute, a skill, a layout, and the like of the piece in the battle region. In this disclosure, the terminal may also be referred to as a terminal device.

A client 131 supporting a virtual environment is installed and run on the second terminal 130. The client 131 may be the client of the turn-based board game program. When the second terminal 130 runs the client 131, a user interface of the client 131 is displayed on a screen of the second terminal 130. The client may be the client of the auto chess game. The second terminal 130 is a terminal used by a second user 113. In a battle preparation phase of a battle, the second user may use the second terminal 130 to arrange a piece in a battle region in a battle interface, and the second terminal 130 or the server 120 automatically controls the piece for battling in a battle phase based on an attribute, a skill, a layout, and the like of the piece in the battle region.

In some aspects, the piece arranged by the first user 112 via the first terminal 110 and the piece arranged by the second user 113 via the second terminal 130 are located in different battle regions on a same board, that is, the first user 112 and the second user 113 are located in a same board of a same battle. Alternatively, the piece arranged by the first user 112 via the first terminal 110 and the piece arranged by the second user 113 via the second terminal 130 are located on different boards, that is, the first user 112 and the second user 113 are located in different boards of a same battle. In an aspect, six user accounts participate in a battle of the turn-based board game. The six user accounts are matched in pairs in each turn, and the two matched user accounts battle against each other in a same board in the current turn.

In some aspects, the client installed on the first terminal 110 is the same as the client installed on the second terminal 130, or the clients installed on the two terminals are clients of a same type on different control system platforms (Android or iOS). The first terminal 110 may generally be one of a plurality of terminals, and the second terminal 130 may generally be another one of the plurality of terminals. In this disclosure, the first terminal 110 and the second terminal 130 are used as an example for description. Device types of the first terminal 110 and the second terminal 130 are the same or different. The device type includes at least one of a smartphone, a tablet computer, an e-book reader, a moving picture experts group audio layer 3 (MP3) player, a moving picture experts group audio layer 4 (MP4) player, a laptop portable computer, a desktop computer, an intelligent robot, a virtual reality (VR) device, an augmented reality (AR) device, or a mixed reality (MR) device. In the following aspects, an example in which a terminal includes a smartphone is used for description.

In an aspect, more or fewer terminals may be provided. For example, there may be only one terminal (that is, a user battles against artificial intelligence), or there may be six, eight, or more terminals. A quantity and device types of terminals are not limited in this disclosure.

FIG. 1 shows only two terminals, but a plurality of other terminals 140 may access the server 120 in a different example. In some aspects, there is one or more terminals 140 corresponding to a developer. A development and editing platform of the client supporting a virtual environment is installed on the terminal 140. The developer may edit and update the client on the terminal 140, and transmit an updated client installation package to the server 120 by using a wired or wireless network. The first terminal 110 and the second terminal 130 may download the client installation package from the server 120 to implement update of the client.

The first terminal 110, the second terminal 130, and the other terminal 140 are connected to the server 120 by using a wireless network or a wired network.

The server 120 includes at least one of one server, a plurality of servers, a cloud computing platform, and a virtualization center. The server 120 is configured to provide a background service for a client (for example, the client of the turn-based board game or the client of the auto chess game) supporting a three-dimensional virtual environment. In some aspects, the server 120 is in charge of primary computing work, and the terminal is in charge of secondary computing work. Alternatively, the server 120 is in charge of secondary computing work, and the terminal is in charge of primary computing work. Alternatively, the server 120 and the terminal perform collaborative computing by using a distributed computing architecture.

In an example, the server 120 includes a processor 122, a user account database 123, a battle service module 124, and a user-oriented input/output interface (I/O interface) 125. The processor 122 is configured to load an instruction stored in the server 120, and process data in the user account database 123 and the battle service module 124. The user account database 123 is configured to store data of user accounts used by the first terminal 110, the second terminal 130, and the other terminal 140, for example, avatars of the user accounts, nicknames of the user accounts, combat power indexes of the user accounts, and service regions for the user accounts. The battle service module 124 is configured to provide a plurality of battle rooms for users to battle against each other. The user-oriented I/O interface 125 is configured to establish communication with the first terminal 110 or the second terminal 130 by using the wireless network or the wired network for data exchange.

An aspect of this disclosure provides a turn-based board game (for example, the foregoing auto chess game) based on a card operation. Various complex operations such as shop purchase, shop upgrade, piece preparation, piece deployment, piece upgrade, and piece equipping in a related auto chess game are all simplified in a card-based playing procedure. On the one hand, the card-based playing procedure is relatively simple, and is suitable for use on a small-screen terminal such as a mobile phone or a tablet computer. On the other hand, a three-dimensional model of a piece can carry only limited text information, and a card face of a card can carry more information such as a “label”, a “value”, an “attribute”, and an “entry effect”, helping improve utilization efficiency of a display region in which the card is located.

The following describes the technical solution provided in this disclosure by using a method aspect.

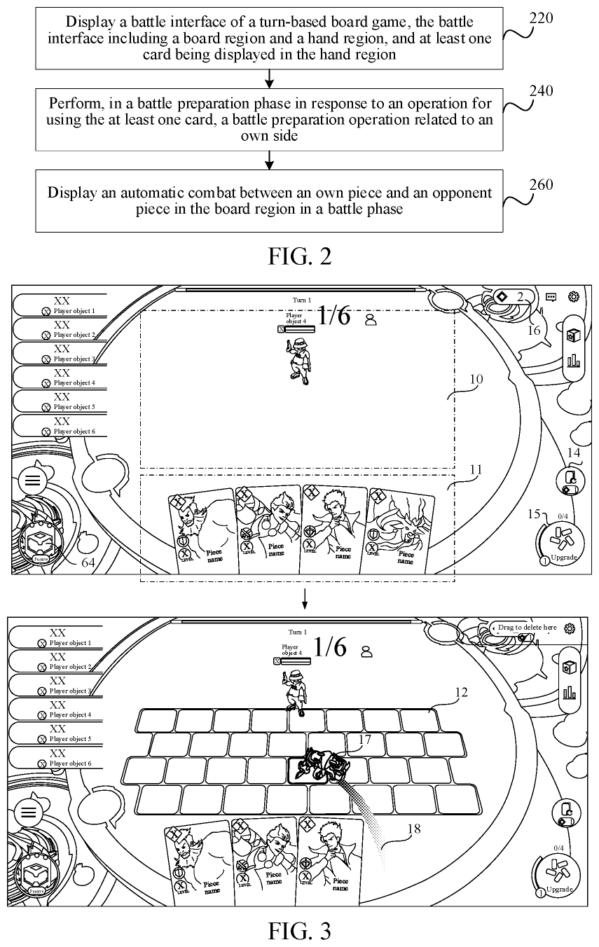

FIG. 2 is a flowchart of a battle interaction method for a turn-based board game according to an aspect of this disclosure. In an example, the method is performed by a terminal. A client supporting a turn-based board game is run on the terminal. The method may include the following operations (220 to 260).

Operation 220: Display a battle interface of a turn-based board game, the battle interface including a board region and a hand region, and at least one card being displayed in the hand region.

The battle interface is an interface for two player objects to perform a turn-based battle in the turn-based board game. The player object may be understood as at least one concept of a user, an account, a player, a chess player, and a virtual chess player. The hand region may be configured for displaying the card. The card may include a piece card in an example. The board region may be configured for displaying a virtual character. There is a correspondence between a piece card and a virtual character. For example, the piece card may be constructed based on the virtual character.

With reference to FIG. 3, the battle interface includes a board region 10 and a hand region 11.

The board region 10 is configured for accommodating at least one own piece (for example, an own virtual character) and at least one opponent piece (for example, an opponent virtual character) that participate in a battle. The board region 10 includes a plurality of tiles 12 arranged in an array. The tiles 12 are displayed continuously or displayed at some times. In some aspects, the board region 10 is a two-dimensional board or a three-dimensional board. In an example, the board region 10 is a three-dimensional board viewed from a top-down perspective. The three-dimensional board in this disclosure means that the board is located in a three-dimensional environment, rather than that the board is in a three-dimensional form.

The hand region 11 is configured for displaying the at least one card owned by or dealt to an own player object. The at least one card can be a plurality of cards. The at least one card includes at least one of a card automatically drawn or distributed by a background program to the own player object, a card obtained by playing some cards with a card-drawing effect, and a chess player card that can be obtained due to a chess player skill. There is an upper limit on a quantity of the plurality of cards, for example, a maximum of eight cards, and excess cards are automatically discarded.

In some aspects, the plurality of cards is arranged in a fan shape in the hand region 11, and an arrangement sequence may be determined based on at least one of the following factors: drawing time, a card type, a quantity of cards of a same type, a quantity of a same card, and card quality. In some aspects, there is an upper limit on the at least one card that the own player object has, for example, a maximum of eight or 10 cards, and a card exceeding the upper limit is discarded. The own player object may play all or a part of cards in each battle turn. In some aspects, in each battle turn, the own player object may alternatively replace all or a part of cards. In some aspects, different cards are of different card types. Different card types have different battle preparation functions.

A battle of the turn-based board game includes a plurality of turns. Each turn includes a battle preparation phase and a battle phase.

Operation 240: Perform, in the battle preparation phase in response to an operation for using the at least one card, a battle preparation operation related to an own side.

An operation for using a card may be referred to as a card playing operation. For example, the card playing operation may be an operation of playing one or more cards the player has. For example, the card playing operation is an operation of dragging a selected card to the board region. Alternatively, the card playing operation includes a first tap operation and a second tap operation. The first tap operation is an operation of tapping to select a card, and the second tap operation is an operation of tapping a tile in the board region. A specific form of the card playing operation is not limited in this disclosure. In some aspects, an intelligent card playing recommendation function may be further provided, to play cards instead of the own player object in some turns. For example, a client intelligently recommends to-be-played cards for a novice player in the first several turns. The own side may be the own player object, for example, a user account logging in to a client for displaying the battle interface.

The at least one own piece is a virtual piece participating in the battle in at least one turn (including a current turn). When the board region is a two-dimensional board, the virtual piece is a two-dimensional piece, and is displayed as a two-dimensional icon or a two-dimensional image. When the board region is a three-dimensional board, the virtual piece is a three-dimensional piece, and is displayed as a three-dimensional model or a three-dimensional image. In an initial state, there may be zero own pieces located in the board region, and the own player object adds, deletes, or replenishes own pieces in the board region. An own piece that is not defeated in a previous turn may be automatically carried over to a next turn. In some aspects, all own pieces in the previous turn may be automatically carried over to the next turn.

A display status of a selected card is different from a display status of an unselected card. In some aspects, the selected card has a highlighting effect, and the highlighting effect includes at least one of the following: a bold frame, a highlighted frame, a dynamic frame, or a movement of a placement location in a card queue to the board region by a preset distance. The selected card is a card selected by the own player object, and the unselected card is a card not selected by the own player object.

The battle preparation operation includes at least one of adding an own piece, reducing an own piece, upgrading the own piece, adding equipment to the own piece, reducing equipment of the own piece, and adding a bonus effect to the own piece.

Because different card types have different effects, the battle preparation operation may be performed on the at least one own piece in the board region by using at least one row of cards based on a card type of the selected card.

In the battle preparation phase, the own player object prepares the at least one own piece in the board region, and an opponent player object prepares the at least one opponent piece in the board region.

Operation 260: Display an automatic combat between the own piece and the opponent piece in the board region in the battle phase.

An automatic combat process of the own piece and the opponent piece in the board region does not need to be manually controlled by the own player object. The client or a server may automatically control, based on factors such as tile locations of the pieces of both sides on the board, piece attributes, levels of the pieces, skills of the pieces, attributes of the pieces, and joint enhancement attributes between the pieces, the pieces of both sides to battle against each other, until all pieces of one side are defeated.

Both the own player object and the opponent player object have a health value. After the current turn ends, a part of the health value of the player object of a losing side is deducted. The part of the health value may be determined based on a quantity of remaining pieces of a winning side, or may be a fixed value. This is not limited in this disclosure.

Based on foregoing, according to the method provided in this aspect, a “card” mechanism is introduced into the turn-based board game to simplify and integrate a plurality of battle preparation operations into a playing process of a plurality of cards. A shop concept is eliminated, so that players do not need to complete the obtaining, upgrading, and battling of pieces based on a plurality of interactions between a plurality of sub-regions such as a shop, a piece preparation region, and a piece battle region in a related battle interface. In addition, a related piece purchase process requiring active selection by a user is changed into passively receiving a dealt card, a game system performs a part of complex operations instead of the user, and the user can complete a plurality of battle preparation operations only by using a card playing operation basically the same as that of a card game. This helps improve human-computer interaction efficiency.

For example, when the turn-based board game is operated on a small-screen terminal such as a mobile phone or a tablet computer, the player may complete a plurality of battle preparation operations based on limited operations in the hand region. Compared with a related auto chess, this can improve the human-computer interaction efficiency.

The following describes classification of card types in this disclosure.

In some aspects, the card type includes at least one of a piece card, an effect card, an equipment card, and a chess player card.

### Piece Card

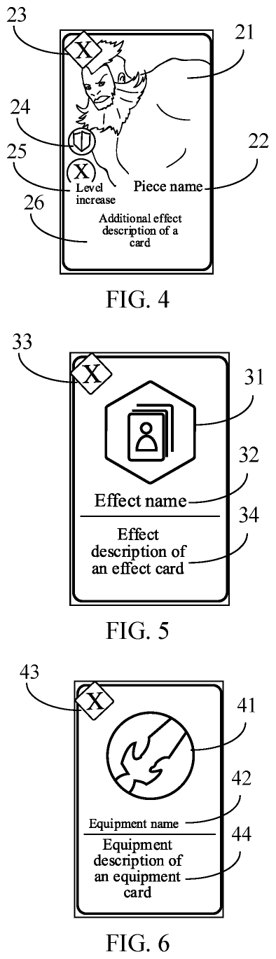

The piece card is a card configured for summoning an own piece or upgrading a piece level of an own piece in the board region. FIG. 4 is a schematic card diagram of a piece card. The piece card displays at least one of the following information: a piece image 21, a piece name 22, an energy value 23 consumed when the card is played, a piece type or a faction 24 to which the piece belongs, a level increase 25 of the piece after the card is played (in some aspects, when the piece corresponding to the piece card does not be deployed, the level increase 25 may also represent an initial level of the piece), and an additional effect description 26 of the piece. In an example, the piece may also be referred to as a virtual piece or a virtual character. Playing a card is a process of using the card.

The piece image 21 may be at least one of an avatar, an icon, a bust, a full-length image, and a presentation animation of the virtual piece. In FIG. 4, an example in which the piece image 21 is the bust of the virtual piece is used for description.

The piece name 22 is a name of the virtual piece. An example in which the virtual piece is a hero is used. In this case, the piece name is a name of the hero.

The energy value 23 is a value of energy (that is, a cost) that needs to be consumed when the piece card is played. The energy value is an integer. The energy is a resource in the turn-based board game. In some aspects, cards of different quality consume different amounts of energy when played. For example, five cards of different quality respectively need to consume zero, one, two, three, and four energy points when played.

The piece type 24 is a classification attribute of a character played by the piece in a battle process. In an example, different pieces may be classified into at least one of the following piece types: a tank, a warrior, an assassin, a wizard, a shooter, and a support. In some aspects, when the piece is represented by a virtual character, the piece type may also be referred to as a character type. The faction is a classification attribute that pieces belong to a same piece group in a virtual world view. In an example, different pieces may be classified into at least one of a faction A, a faction B, a faction C, a faction D, a faction F, and a faction D. For example, two pieces belonging to the faction A in the virtual world view belong to the faction A. In a different aspect, the piece type and the faction may be considered as a same classification attribute. In an example, the piece type and the faction are different classification attributes.

The level increase 25 of the piece after the card is played is a quantity of levels by which an existing same-name piece is upgraded after the card is played when there is a same-name piece (that is, a same piece) in the board region. For example, the level increase 25 is three levels, and the same-name piece is originally at level 2. In this case, after the card is played, the same-name piece is upgraded to level 5. In some aspects, cards of different quality upgrade same-name pieces by different quantities of levels after played. For example, five cards of different quality respectively upgrade the same-name pieces by one level, two levels, three levels, four levels, and five levels after played.

The additional effect description 26 of the piece is an effect description of an additional effect of the piece. The additional effect may be triggered to take effect when the card is played, or may take effect when a trigger condition is satisfied in the battle process. For example, an exclusive skill of a piece 1 (that is, a talent of the piece) is: when the piece 1 is on the board, each time another own piece in the board region is sold, an own piece on the board whose piece type is the “tank” is selected in various manners, and a level of the selected own piece on the board is increased by a first value, the first value being half a level of the sold piece.

### Effect Card

The effect card is a card configured for applying an effect to at least one game factor in a game battle. The at least one game factor includes at least one of the following: a piece, a skill, equipment, a bonus effect, a grade, a battle process, and a hand obtaining process. FIG. 5 is a schematic card diagram of an effect card. The effect card displays at least one of the following information: an effect icon 31, an effect name 32, an energy value 33 consumed when the card is played, and an effect description 34 of the effect card.

The effect icon 31 may be an icon configured for representing a bonus effect of the effect card. In FIG. 5, an example in which an outer frame is a hexagon is used for description. The effect name 32 is a name of the effect card or a name of the bonus effect.

The energy value 33 is configured for indicating a value of energy that needs to be consumed when the effect card is played. The energy value is an integer. The energy is a resource in the turn-based board game. In some aspects, cards of different quality consume different amounts of energy when played. For example, five cards of different quality respectively need to consume zero, one, two, three, and four energy points when played.

The effect description 34 of the effect card is configured for describing an effect of the effect card after use. The effect of the effect card includes but is not limited to at least one of the following:
1: enhancing at least one of a probability of obtaining a piece card by an own chess player and a quantity of piece cards obtained;
2: enhancing at least one of a probability of obtaining, by the own chess player, a same-name piece card associated with a piece on the board and a quantity of same-name piece cards obtained;
3: reducing energy that needs to be consumed when the own chess player obtains a piece card;
4: increasing a quantity of piece cards obtained by the own chess player during piece card replacement;
5: reducing energy that needs to be consumed for piece card replacement by the own chess player;
6: increasing a piece level of at least one piece on the board;
7: adding equipment to the at least one piece on the board;
8: increasing an equipment level of the at least one piece on the board;
9: reducing energy consumption during card playing or card replacement;
10: increasing a probability of obtaining some cards;
11: increasing a quantity of some cards obtained; and
12: adding a card replacement chance, and so on, with details not described again.

For example, an effect of a “two companions” card is obtaining two identical hero cards in various manners (for example, randomly); an effect of a “talent search” card is selecting one of three highest-quality hero cards available at a current chess player level; an effect of a “duplicate” card is obtaining a same-name card of a hero on the board in various manners (for example, randomly); an effect of a “bountiful harvest” card is immediately replenishing the hand to five cards; an effect of a “random boost” card is increasing a level of a hero on the board in various manners (for example, randomly), such as by 5; an effect of an “once more” card is drawing a card, and obtaining an additional free card replacement chance in the current turn; an effect of a “prayer” card is an energy value consumed by all cards minus 1; and an effect of an “extra cards” card is drawing two cards.

In some aspects, the effect card may be classified into at least one of a universal effect card, a piece type effect card, and a faction effect card. The universal effect card is an effect card whose card attribute is unrelated to the piece type/faction, and the card attribute includes at least one of an obtaining condition, a use condition, a card effect, and an effect range. The piece type effect card is an effect card whose card attribute is related to the piece type, for example, a card whose card effect can be obtained, used, or enjoyed only by a piece of a specified piece type. The faction effect card is an effect card whose card attribute is related to the faction, for example, a card whose card effect can be obtained, used, or enjoyed only by a piece of a specified faction.

For example, an effect card of a piece type may be obtained at a specific probability only when a piece card of the piece type is played.

### Equipment Card

The equipment card is a card configured for equipping at least one own piece. FIG. 6 is a schematic card diagram of an equipment card according to an aspect of this disclosure. As shown in FIG. 6, the equipment card displays at least one of the following information: an equipment icon 41, an equipment name 42, an energy value 43 consumed when the card is played, and an equipment description 44 of the equipment card.

The equipment icon 41 may be an icon configured for representing an equipment image or an equipment effect. In FIG. 6, an example in which an outer frame is a circle is used for description. The equipment name 42 is a name of the equipment card or a name of the equipment. Different equipment may enhance a combat capability of the own piece or reduce a combat capability of the opponent piece in different dimensions such as hit points, armor, defense, and magic points.

The energy value 43 is a value of energy that needs to be consumed when the equipment card is played. The energy value is an integer. The energy is a resource in the turn-based board game. In some aspects, cards of different quality consume different amounts of energy when played. For example, five cards of different quality respectively need to consume zero, one, two, three, and four energy points when played. In some aspects, energy values consumed by different cards may be periodically or aperiodically adjusted based on the balance of the game.

The equipment description 44 of the equipment card is configured for describing an effect of the equipment after equipping.

### Chess Player Card

The chess player card is a card acquired by using a chess player skill of a chess player character. The chess player card may be a card that is triggered to be obtained by a passive skill of the chess player character, may be a card that can be obtained by only a chess player character, may be a card that can be used by only a chess player character, may be a card exclusive only to a chess player character, or the like. This is not limited in this disclosure.

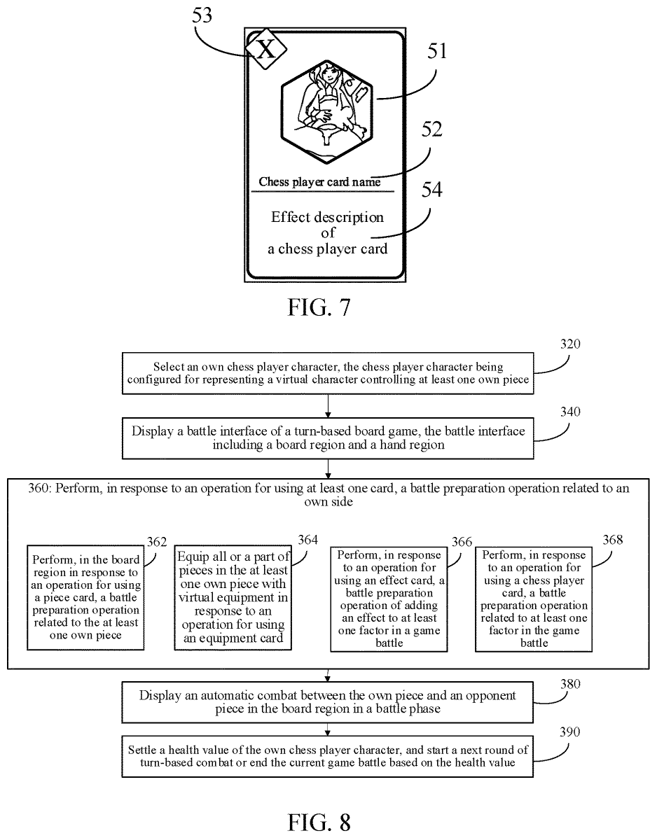

FIG. 7 is a schematic card diagram of a chess player card according to an aspect of this disclosure. As shown in FIG. 7, the chess player card displays at least one of the following information: a card icon 51, a chess player card name 52, an energy value 53 consumed when the card is played, and an effect description 54 of the chess player card.

The card icon 51 may be an icon configured for representing a card effect. In FIG. 7, an example in which an outer frame is a hexagon is used for description. The chess player card name 52 is a name of the chess player card or a name of an effect.

The energy value 53 is a value of energy that needs to be consumed when the chess player card is played. The energy value is an integer. The energy is a resource in the turn-based board game. In some aspects, cards of different quality consume different amounts of energy when played. For example, five cards of different quality respectively need to consume zero, one, two, three, and four energy points when played. In some aspects, energy values consumed by different cards may be periodically or aperiodically adjusted based on the balance of the game.

The effect description 54 of the chess player card is configured for describing an effect that can be generated after the chess player card is used. The effect of the chess player card may be the same as or similar to those of the piece card, the equipment card, and the effect card, or may exceed effect scopes of the piece card, the equipment card, and the effect card. In an implementation example the effect of the chess player card may be designed into an effect in any one of at least one of the following: summoning a piece, upgrading a piece, adding equipment, adding a bonus effect, reducing energy consumption, affecting a hand obtaining procedure, and another effect in any form. The effect of the chess player card may be designed to affect any procedure or detail in the game battle. This is not limited in this disclosure.

As can be seen from the descriptions of the foregoing four types of cards, on the one hand, different types of cards have different functions. With the piece card, the shop in the related auto chess can be eliminated based on a playing characteristic of the card. With the effect card, an effect button or control in the related auto chess can be eliminated. With the equipment card, a jungle phase in the related auto chess can be eliminated. With the chess player card, a gameplay characteristic related to the chess player can be integrated. According to an aspect of this disclosure, different mechanisms in the turn-based board game are simplified to the card playing procedure based on different types of cards. This helps reduce user interface elements that need to be displayed in the battle interface, and can also reduce operation difficulty of the own player object, helping improve the human-computer interaction efficiency of the own player object.

On the other hand, a comparison between a two-dimensional card and a three-dimensional piece shows that the three-dimensional piece can carry limited text information, so that the three-dimensional piece cannot well carry text information; and the two-dimensional card can carry more text information and icon information due to a card characteristic of the two-dimensional card, so that the two-dimensional card can better increase an amount of information carried in a limited display range of the small-screen terminal than the three-dimensional piece in a related battle preparation phase, helping improve information transmission efficiency.

The cards not only can be played in the battle preparation phase, but also include some cards that can be played in the battle phase, for example, some equipment cards and effect cards indicating to immediately draw two more cards.

The following describes a card obtaining manner in this disclosure.

The own player object obtains at least one card when an obtaining condition is satisfied. The obtaining condition includes at least one of the following.
Obtaining condition 1: is that a new round of turn-based combat is started. Each time a new round of turn-based combat is started, a plurality of cards are obtained. For example, four cards are drawn in a first round of turn-based combat, and two cards are drawn in a subsequent round of turn-based combat.
Obtaining condition 2: is that a preset piece card is used. The preset piece card is a piece card with an additional skill such as drawing, adding, or duplicating a piece card. For example, an effect card is additionally obtained when a same-name piece card corresponding to a piece on the board is played.
Obtaining condition 3: is that a preset effect card is used. The preset effect card is an effect card with a functional effect such as drawing, adding, or duplicating a card.
Obtaining condition 4: is that a preset chess player card is used. The preset chess player card is an effect card with a functional effect such as drawing, adding, or duplicating a card.
Obtaining condition 5: is that a resource owned by the own side is consumed for replacement. For example, energy is consumed for drawing or replacement.
Obtaining condition 6: is that a chess player level of a chess player character is upgraded. After the chess player level is upgraded, a higher-quality card or a larger quantity of cards can be unlocked and obtained.
Obtaining condition 7: is that a card pool level is upgraded. After the card pool level is upgraded, a higher-quality card or a larger quantity of cards can be unlocked and obtained.
Obtaining condition 8: is a card purchase operation.
Obtaining condition 9: is that a preset chess player skill is triggered. The preset chess player skill is a passive skill with a functional effect such as drawing, adding, or duplicating a card. For example, one chess player card may be drawn every two turns, and one chess player card may be drawn each time three cards are played.

The obtaining condition may be combined. For example, some cards can be obtained by using a preset chess player card after the chess player level reaches level 2. In addition, obtaining conditions of different types of cards may be different, or may be the same, or one part of the conditions may be the same and the other part of the conditions may be different. This is not limited in this disclosure.

FIG. 8 is a flowchart of a battle interaction method for a turn-based board game according to another aspect of this disclosure. In an example, the method is performed by a terminal device. The method may include the following operations (320 to 390).

### Chess Player Selection Phase

Operation 320: Select an own chess player character, the chess player character being configured for representing a virtual character controlling at least one own piece.

Before a game battle is started each time, an own player object selects a desired chess player character. Different chess player characters have different chess player skills. The chess player skill can be related to obtaining a chess player card, but may alternatively be related to another game factor.

In some aspects, different chess player skills have some respective passive trigger mechanisms, to enable the own player object to obtain some cards with special effects. For example, a skill effect of a chess player character is that one treasure chess player card is obtained each time three piece cards are played. An effect of the treasure player card is consuming one energy point, to specify a level of an own piece in a board region to be increased by 2.

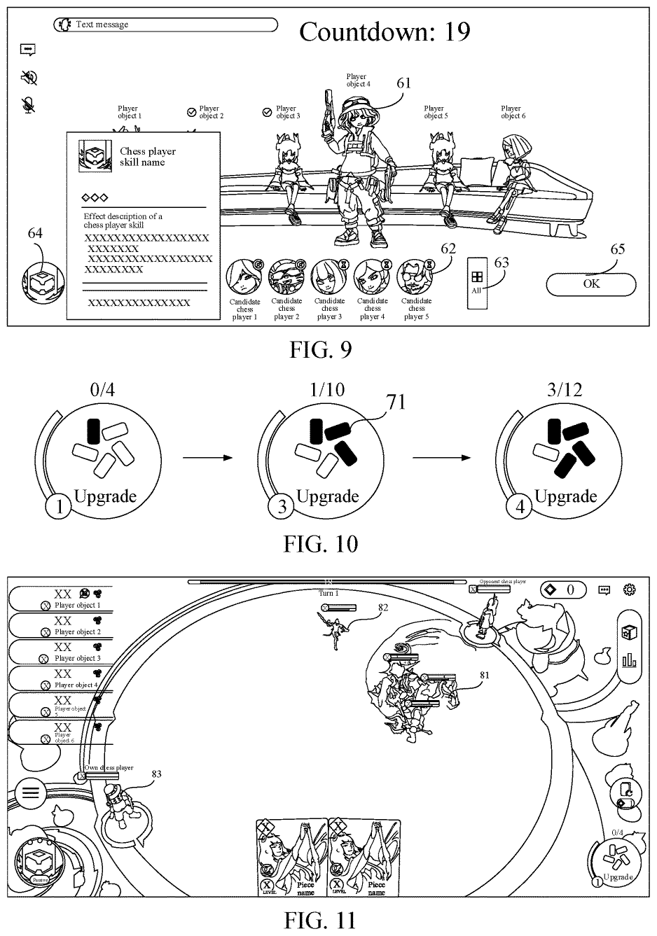

For example, as shown in FIG. 9, before a game battle is started, a client displays a chess player selection interface. Chess player characters respectively selected by six player objects are displayed in the chess player selection interface. In some aspects, a chess player character 61 selected by the own player object is highlighted. An example in which the own player object is a player object 4 is used. A chess player character selected by the player object 4 is highlighted in a manner of standing, enlargement, and a centered foreground, and a chess player character selected by another player object is displayed in a manner of sitting, a normal size, and distribution on two sides.

The chess player selection interface may further display a plurality of candidate chess player characters 62, for example, candidate chess player characters 1 to 5. Other candidate chess player characters may be viewed by sliding left and right, or all the candidate chess player characters may be viewed by tapping an “All” button 63.

The chess player selection interface may further display a chess player skill button 64. In response to the chess player skill button 64 being tapped, the client may display a chess player skill name of a currently selected chess player character and an effect description in a right pop-up window.

In some aspects, a message transmitted by another player object and a countdown of selecting a chess player character or entering a game battle are displayed at the top of the chess player selection interface. A transmitting button configured for transmitting a text message, an on/off button of a speaker, and an on/off button of a microphone are displayed on the left of the chess player selection interface. After the chess player character selected by the own player object is determined, a user may tap an “OK” button 65 to enter a ready state.

n player objects participating in a game battle perform turn-based combats in pairs. Each turn includes a battle preparation phase and a battle phase.

### Battle Preparation Phase of Each Turn

Operation 340: Display a battle interface of a turn-based board game, the battle interface including a board region and a hand region.

With reference to FIG. 3, a board region 10 is configured for placing at least one own piece and at least one opponent piece. In some aspects, an upper half of the board region 10 is configured for placing the at least one opponent piece, and a lower half of the board region 10 is configured for placing the at least one own piece. The hand region 11 is configured for displaying at least one card owned by the own player object. In an initial state or in some cases (for example, all cards in a current turn are played), a quantity of cards displayed in the hand region 11 is 0.

In some aspects, attribute information of the n player objects participating in the current game battle is further displayed at a top-left corner of the battle interface. The attribute information includes at least one of a player nickname, a player avatar, hit points of the player, and a chess player level of the player. The chess player skill button 64 is displayed at a bottom-left corner of the battle interface. A card replacement button 14 and an upgrade button 15 are further displayed at a bottom-right corner of the battle interface. The card replacement button 14 is configured for replacing one or more cards in the hand region 11. The upgrade button 15 is configured for upgrading a level of the chess player character, to unlock a card, a capability, and equipment of a higher level.

In some aspects, an energy control 16 is further displayed at a top-right corner of the battle interface. The energy control 16 is configured for displaying an energy value of the own player object. Energy is a game resource, and energy may need to be used in each phase of the entire game battle. For example, energy needs to be consumed for playing a card, energy needs to be consumed for replacing a card, and energy needs to be consumed for upgrading a chess player level.

Operation 360: Perform, in response to an operation for using the at least one card, a battle preparation operation related to an own side.

A card type includes at least one of a piece card, an equipment card, an effect card, and a chess player card. The own player object may perform battle preparation operations with different functions by using card playing operations for different piece cards. This operation includes at least one of the following operations.

Operation 362: Perform, in the board region in response to an operation for using the piece card, a battle preparation operation related to the at least one own piece.

Step 364: Equip all or a part of pieces in the at least one own piece with virtual equipment in response to an operation for using the equipment card.

Operation 366: Perform, in response to an operation for using the effect card, a battle preparation operation of adding an effect to at least one factor in the game battle.

Operation 368: Perform, in response to an operation for using the chess player card, a battle preparation operation related to the at least one factor in the game battle.

Because combat situations of the turn-based combats are different, cards of the player objects are different, and playing habits of the player objects are different, quantities of times and sequences of execution of operation 362, operation 364, operation 366, and operation 368 in the turn-based combats may be different. This is not limited in this disclosure.

For operation 362 (the piece card)

In some aspects, the card located in the hand region includes a first piece card. A first own piece is added to the board region in response to an operation for using the first piece card, the first own piece being a piece corresponding to the first piece card. In some aspects, the first own piece is a piece not summoned to the board region.

In other words, when the first own piece does not exist in the board region, the first own piece is added to the board region in response to a card playing operation on the first piece card.

The client displays at least two candidate tiles and a first indication element corresponding to the first piece card in the board region in response to the operation for using the first piece card, the first indication element including at least one of a scaled-down first piece card, the first own piece, and a first indication arrow; and adds the first own piece to a first candidate tile in response to an operation for dragging the first indication element to the first candidate tile, the first candidate tile being one of the at least two candidate tiles.

The at least two candidate tiles may be all candidate tiles, or may be candidate tiles belonging only to the own side. The at least two candidate tiles may be displayed continuously or displayed only when a card playing operation is recognized.

An example in which the first piece card is a 4^{th} card in FIG. 3 is used. With reference to FIG. 3, a first own piece 17 and a first indication arrow 18 are displayed in response to a drag operation of dragging the first piece card. The first own piece 17 is a three-dimensional piece, and can slide along with a real-time location of the drag operation. A start point of the first indication arrow 18 is a location of the first piece card before the first piece card is played, and an end point is the real-time location of the drag operation. When a release location of the drag operation is the first candidate tile, the first own piece 17 is summoned to the first candidate tile.

As can be seen from FIG. 3, in this interaction manner, a piece preparation region is eliminated, and the hand region considers both piece obtaining and preparation functions. This implements sharing of one display region by a plurality of functions, helping improve human-computer interaction efficiency.

In some aspects, the card located in the hand region includes a second piece card. In response to a card playing operation on a second piece card, the client upgrades a piece level of a second own piece in the board region when the second own piece already exists in the board region, the second own piece being a piece corresponding to the second piece card.

The card playing operation on the second piece card may alternatively be a drag operation. However, because the second own piece already exists in the board region, a release location of the drag operation may be any location in the board region, and the second piece card can take effect, without a need for the own player object to accurately drag the second piece card to the second own piece.

For operation 364 (the equipment card)

In some aspects, the card located in the hand region includes an equipment card. The client displays, in response to a card playing operation on the equipment card, a second indication element corresponding to the equipment card, the second indication element including at least one of a scaled-down equipment card, virtual equipment corresponding to the equipment card, and a second indication arrow. The client equips the second own piece with the virtual equipment in response to a drag operation for dragging the second indication element to the second own piece, the second own piece being an own piece already existing in the board region.

For operation 366 (the effect card)

In some aspects, the card located in the hand region includes an effect card. In response to a card playing operation on the effect card, the client performs at least one of the following operations: adding an effect to the at least one own piece, and adding an effect to a card obtaining procedure.

The effect card may be classified into two major types based on an acting object:
Type 1: adding the effect to the own piece in the board region; and
Type 2: adding the effect to the card obtaining procedure.

In response to a card playing operation on an effect card of Type 1, the client adds the effect to the at least one own piece, for example, adds a piece type-specific bonus specific to a piece type and a joint bonus when at least two pieces of a same faction are on the board.

In response to a card playing operation on an effect card of Type 2, the client adds the effect to the card obtaining procedure, for example, supports continuous drawing of two identical piece cards.

For operation 368 (the chess player card)

At least one of the following battle preparation operations is performed in response to a card playing operation on the chess player card:
addition of an own piece, reduction of an own piece, an increase in a piece level of the own piece, addition of an effect to the own piece, equipping of the own piece with a prop, an operation related to card obtaining, an operation related to card selling, an operation related to card replacement, an operation related to a subsequent turn, and an operation related to a health value of the own player object.

In other words, a function of the chess player card is relatively special, and may be a function of any one of the piece card, the equipment card, and the effect card, may be a function related to the card obtaining procedure, or may be a function related to a health value of a chess player. In different design implementations, a function that can affect a factor in the game battle may be designed as the function of the chess player card. This is not limited in this disclosure.

In the battle preparation phase, the own player object may further use at least one of a card replacement function, a card deletion function, and a chess player level upgrade function.

### Card Replacement Function

In the battle preparation phase, the own player object may further replace one or more cards in the hand region. For example, the user may replace the one or more cards by tapping the card replacement button. Energy needs to be consumed for replacing a card. For example, card replacement can be performed only once in each turn, a plurality of cards can be replaced at one time, and one energy point is consumed for replacing any quantity of cards.

### Card Deletion Function

In a card playing process, a card may be deleted or sold by dragging the card to a specified location. A resource consumed by the deleted card cannot be recycled or can be recycled partially, or fixed energy can be recycled. For example, each time a card is deleted, one energy point may be obtained.

### Chess Player Level Upgrade Function

The own player object obtains a plurality of pieces of energy in each turn. Energy not used in the current turn may be accumulated to a next turn, and the chess player level may be increased by using the energy. If the chess player level is higher, quality of a card that may be drawn in each turn is higher, and some new capabilities may be unlocked, for example, a talent and purchasable equipment. In some aspects, quality identifiers of different colors may be displayed on the upgrade button 15. As the chess player level rises, the client turns on a quality identifier corresponding to a current chess player level, to indicate a card quality that can be obtained at the current player level. The quality identifier may be a small circular rectangle 71 shown in FIG. 10, or may be in another shape or form.

For example, the own player object respectively unlocks cards of quality 1, 2, 3, 4, and 5 when the chess player level is 1, 2, 3, 4, and 5.

### Battle Phase of Each Turn

Operation 380: Display an automatic combat between the own piece and the opponent piece in the board region in the battle phase.

An automatic combat process of the own piece and the opponent piece in the board region does not need to be manually controlled by the own player object. The client or a server may automatically control, based on factors such as tile locations of the pieces of both sides on the board, piece attributes, levels of the pieces, skills of the pieces, attributes of the pieces, and joint enhancement attributes between the pieces, the pieces of both sides to battle against each other, until all pieces of one side are defeated.

FIG. 11 is a schematic diagram of an automatic melee combat between an own piece 81 and an opponent piece 82 in a board region. None of the actions such as movement, skill casting, and the function of the pieces of both sides in the combat process need to be manually controlled by the player.

### Combat Settlement Phase

Operation 390: Settle a health value of the own chess player character, and start a next round of turn-based combat or end the current game battle based on the health value.

Both the own player object and an opponent player object have a health value (for example, the health value of the chess player character). After the current turn ends, a part of the health value of the player object of a losing side is deducted. The part of the health value may be determined based on a quantity of remaining pieces of a winning side, or may be a fixed value. This is not limited in this disclosure.

When the health value is deducted to zero, the own player object is eliminated from the current game battle.

When the health value is not deducted to zero, the own player object starts a next round of turn-based combat in the current game battle, to continue to combat with one of the n player objects until being eliminated or winning the game battle as a last non-eliminated side.

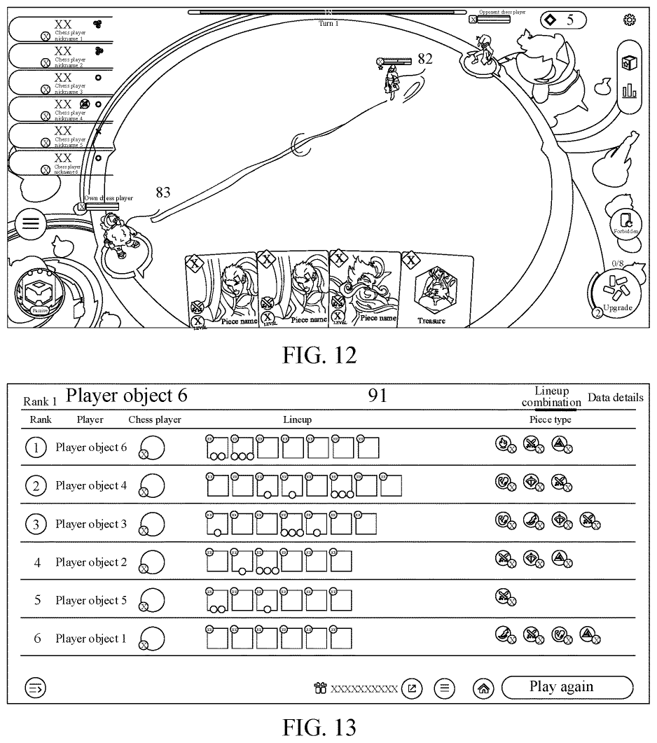

In some aspects, damage settlement is determined based on a quantity of remaining pieces of the winning side on the board. FIG. 12 shows an animation effect of settling a health value of an own piece character 83 when the own side is the losing side and there is one remaining opponent piece 82. A health value progress bar may be displayed above the head of the piece character 83.

For example, refer to FIG. 13. Settlement information of the current game battle is displayed in a settlement interface 91. The settlement information includes information such as a rank of the player, a chess player character used by each player, a piece lineup, and a piece type.

According to the method provided in this aspect, a “card” mechanism is introduced into the turn-based board game to simplify and integrate a plurality of battle preparation operations into a playing process of a plurality of cards. A shop concept is eliminated, so that players do not need to complete the obtaining, upgrading, and battling of pieces based on a plurality of interactions between a plurality of sub-regions such as a shop, a piece preparation region, and a piece battle region in a related battle interface. In addition, a related piece purchase process requiring active selection by a user is changed into passively receiving a dealt card, a game system performs a part of complex operations instead of the user, and the user can complete a plurality of battle preparation operations only by using a card playing operation basically the same as that of a card game. This helps improve human-computer interaction efficiency.

For example, when the turn-based board game is operated on a small-screen terminal such as a mobile phone or a tablet computer, the player may complete a plurality of battle preparation operations based on limited operations in the hand region. Compared with a related auto chess, this can improve the human-computer interaction efficiency.

According to the method provided in this aspect, with the piece card, a shop in a related auto chess can be eliminated based on a gameplay characteristic of the card. Therefore, an original cumbersome process in which the user needs to purchase desired pieces from dozens of sellable pieces in the shop is converted into a process in which a game system automatically deals a plurality of cards to the player, and the user does not need to manually select cards. This further reduces a quantity of interactive operations of the user required for obtaining pieces, as well as an amount of information the user needs to process.

According to the method provided in this aspect, with the effect card, an effect button or control in the related auto chess can be eliminated. With the equipment card, a jungle phase in the related auto chess can be eliminated. With the chess player card, a gameplay characteristic related to the chess player can be integrated. Different mechanisms in the turn-based board game are simplified to the card playing procedure based on different types of cards. This helps reduce user interface elements that need to be displayed in the battle interface and reduce time spent by the user actively searching for a related function entry, and can also reduce operation difficulty of the own player object, helping improve the human-computer interaction efficiency of the own player object.

The following describes a virtual character level adjustment method provided in an aspect of this disclosure by using an example in which a piece is a virtual character. For content not described in this aspect, refer to the foregoing aspect.

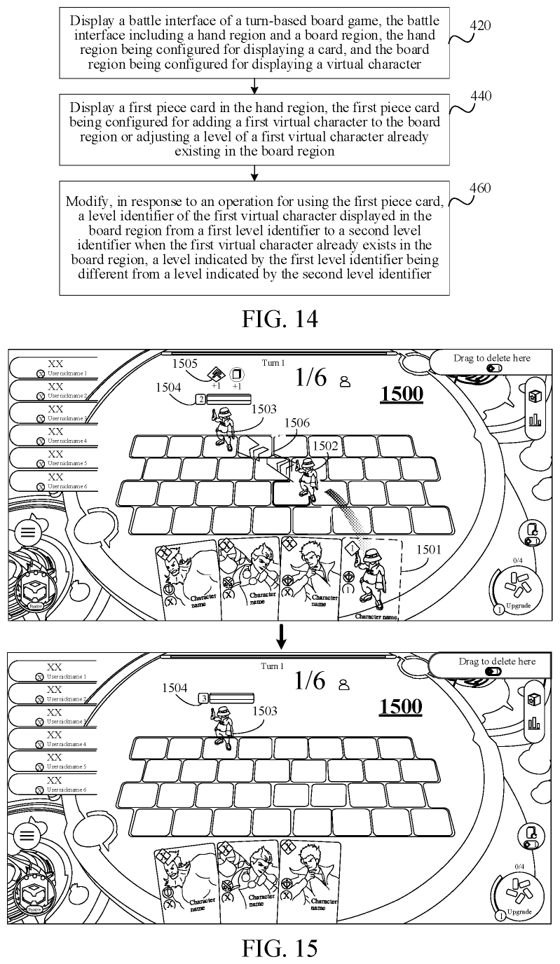

FIG. 14 is a flowchart of a virtual character level adjustment method according to an aspect of this disclosure. In an example, the method is performed by a terminal. A program client supporting a turn-based board game is run on the terminal. The method may include the following operations (420 to 460).

Operation 420: Display a battle interface of a turn-based board game, the battle interface including a hand region and a board region, the hand region being configured for displaying a card, and the board region being configured for displaying a virtual character.

In some aspects, at least one card may be displayed in the hand region, and at least one virtual character may be displayed in the board region. The card may include a piece card. There is a correspondence between a piece card and a virtual character. For example, the piece card may be constructed based on the virtual character.

The battle interface is an interface for two player objects to perform a turn-based battle in the turn-based board game. The battle interface may be configured for displaying battle information of a started game battle in the turn-based board game. The battle information may include information of each player object participating in the game battle, player object information, virtual character lineup (that is, the foregoing piece lineup) information, and card information of both sides of the battle, a battle process, a battle result, a card playing process, a lineup matching process, and the like. This is not limited in this disclosure.

In an aspect, each game battle may include a plurality of battle turns. For each client corresponding to the turn-based board game, a battle interface of the client may be configured for displaying battle information corresponding to each battle turn. The battle information corresponding to the battle turn may be information that needs to be displayed in the battle turn. For example, for a first player object (for example, a first user) corresponding to a first client, the first client may display, by using a battle interface, battle information corresponding to the first player object in each battle turn.

In some aspects, the turn-based board game may be implemented as the foregoing auto chess game, the virtual character is a piece in the auto chess game, and controllers of the card and the virtual character are chess player characters in the auto chess game. The virtual character is a base combat unit in the turn-based board game. An image of the virtual character is not limited in this disclosure, and may be at least one of a human image, an animal image, a plant image, a cartoon image, an animation image, and the like.

The card in this aspect is related to the virtual character. For example, the card may be configured for triggering the deployed virtual character, may be configured for triggering an increase in a level of the virtual character, may be configured for triggering equipping of the virtual character, or may be configured for triggering adding of an effect to the virtual character. This is not limited in this this disclosure. In an example, the card in this aspect includes at least one of a piece card, an effect card, a chess player card, and an equipment card.

The hand region may be configured for displaying a card currently owned by the player object. The card may be issued by a game system. For example, the game system issues two cards in each battle turn. The board region may be configured for displaying a virtual character currently deployed by the player object, that is, a virtual character lineup. In some aspects, the board region may be configured for preparing a battle in a battle preparation phase, for example, matching the virtual character lineup. The board region may be further configured for performing the battle in a battle phase, for example, providing a virtual environment for the battle.

The player object may deploy the virtual character through a card playing operation on the card. The card playing operation is an operation for using the card. For example, the player object may determine, based on an owned energy value, how to use the owned card and a quantity of to-be-used cards. In some aspects, there may be not only a card that needs to consume an energy value for use but also a card that does not need to consume an energy value for use. Energy values (that is, costs) consumed for using a part of cards are the same, and energy values consumed for using most cards are different. The energy value consumed for using the card may be set and adjusted by a designer based on an actual use requirement. This is not limited in this disclosure.

For example, refer to FIG. 15. The client displays a battle interface 1500 of an auto chess game. The battle interface 1500 includes a board region and a hand region. Battle information of a current ongoing battle turn 1 is displayed in the battle interface 1500. For example, four piece cards are displayed in the hand region, and one virtual character (that is, a virtual character 1503) is displayed in the board region. The board region is formed by combining a plurality of tiles, and each tile may be configured for placing one virtual character.

Operation 440: Display a first piece card in the hand region, the first piece card being configured for adding a first virtual character to the board region or adjusting a level of a first virtual character already existing in the board region.

In some aspects, the at least one card includes the first piece card. Alternatively, the client displays the first piece card in the hand region in response to an operation of the player object for obtaining a piece card. The first virtual character may be any virtual character provided in the turn-based board game. The first piece card corresponds to the first virtual character. For example, the first piece card is a piece card corresponding to the first virtual character.

Adding the first virtual character to the board region may additionally display a model of the first virtual character in the board region, so that the model of the first virtual character battles against a model of an opponent virtual character. The level of the first virtual character may be a piece level of the first virtual character. The first virtual character already existing in the board region may be configured for indicating that the first virtual character is used for battling.

In some aspects, the first piece card may be configured for increasing the level of the first virtual character already existing in the board region, or may be configured for decreasing the level of the first virtual character already existing in the board region. This is not limited in this disclosure. The following uses an example in which the first piece card is configured for increasing the level of the first virtual character for description.

For example, refer to FIG. 15. In the battle interface 1500, four cards are displayed in the hand region, the four cards include a first piece card 1501, and the first piece card 1501 is a piece card corresponding to the first virtual character 1503 in the board region. Because the first virtual character 1503 already exists in the board region, the first piece card 1501 may be configured for increasing a level of the first virtual character 1503.

Operation 460: Modify, in response to an operation for using the first piece card, a level identifier of the first virtual character displayed in the board region from a first level identifier to a second level identifier when the first virtual character already exists in the board region, a level indicated by the first level identifier being different from a level indicated by the second level identifier.

In an aspect, the card playing operation may be an operation of playing the card for use. For example, the card playing operation may be a drag operation of dragging a selected card to the board region. Alternatively, the card playing operation may include a first tap operation and a second tap operation. The first tap operation is an operation of tapping to select a card, and the second tap operation is an operation of tapping a tile in the board region. A combination of the first tap operation and the second tap operation may trigger use of the selected card. A specific form of the card playing operation is not limited in this disclosure.

In an example, an example in which the card playing operation is a drag operation is used. Operation 460 may further include the following content.
1: Display a preview model of the first virtual character corresponding to the first piece card in the board region in response to a drag operation for dragging the first piece card from the hand region to the board region.

In some aspects, when a drag distance corresponding to the drag operation is greater than a distance threshold, the client additionally displays, in the board region, the preview model of the first virtual character corresponding to the first piece card. A display location of the preview model is a real-time location of the drag operation, that is, the preview model dynamically moves along with the real-time location of the drag operation. The distance threshold may be set and adjusted based on an actual use requirement. This is not limited in this disclosure. The preview model of the first virtual character may be determined based on the model of the first virtual character. For example, the preview model of the first virtual character may be the same as the model of the first virtual character. Alternatively, the preview model of the first virtual character may be differently displayed from the model of the first virtual character, for example, in color, size, or display effect.

In some aspects, a first indication arrow is displayed between the preview model and the first piece card. A start point of the first indication arrow is a location of the first piece card before the first piece card is played, that is, a location of the first piece card in the hand region. An end point of the first indication arrow is the real-time location of the drag operation. The first indication arrow may be displayed in a guide arrow style.
2: Display a first prompt line between the preview model and the model of the first virtual character when the first virtual character already exists in the board region, the first prompt line being configured for prompting triggering of an increase in the level of the first virtual character by the first piece card.

In an aspect, a virtual character and a piece card corresponding to the virtual character have the same identification information. The identification information of the virtual character is configured for uniquely identifying the virtual character, and is, for example, a name of the virtual character or an identity document (ID) of the virtual character. In some aspects, identification information corresponding to the first piece card is matched with identification information of each virtual character in the board region, and if the same identification information exists, it may be determined that the first virtual character already exists in the board region, or if the same identification information does not exist, it may be determined that the first virtual character does not exist in the board region.

In some aspects, the first prompt line may be a prompt line pointing from the preview model to the model of the first virtual character. A specific style of the first prompt line is not limited in this disclosure, and is, for example, an arrow or a directional marker. The first prompt line may be configured for prompting the player object that the level of the first virtual character may be increased by using the first piece card. This helps the player object obtain information more intuitively, improving convenience of obtaining the information and helping improve the game experience of the player.

For example, refer to FIG. 15. A preview model 1502 corresponding to the first virtual character is displayed in the board region of the battle interface 1500 in response to the player object dragging the first piece card 1501 from the hand region to the board region. When the first virtual character 1503 already exists in the board region, the preview model 1502 is connected to the first piece card 1501 by using the first indication arrow, and the preview model 1502 is connected to a model of the first virtual character 1503 by using a first prompt line 1506.

In some aspects, when the first virtual character already exists in the board region, the client may further display first prompt information near the first virtual character in response to the drag operation for dragging the first piece card from the hand region to the board region. The first prompt information may be configured for prompting triggering of the increase in the level of the first virtual character by the first piece card, as well as a quantity of levels by which the level of the first virtual character can be increased. For example, a style of the first prompt information may be a text style, an icon style, or a value style. This is not limited in this disclosure. For example, refer to FIG. 15. When the first virtual character 1503 already exists in the board region, first prompt information 1505 is further displayed above the first virtual character 1503 in response to the player object dragging the first piece card 1501 from the hand region to the board region. The first prompt information 1505 is configured for indicating that the level of the first virtual character 1503 can be increased by one level by using the first piece card 1501.
3: Display, in response to release of the drag operation, a picture in which the preview model and the model of the first virtual character are fused.

Release of the drag operation means that the player object ends the drag operation. In some aspects, when the player object performs the drag operation with a finger, if the finger leaves a display screen of the terminal, the client may determine that the drag operation is released (that is, the drag operation is ended). When the player object performs the drag operation via a touch device (for example, a touch pen), if the touch device is disconnected from a display screen of the terminal, the client may determine that the drag operation is released (that is, the drag operation is ended).

In some aspects, the client fuses the preview model and the model of the first virtual character in response to release of the drag operation. Alternatively, in response to release of the drag operation, the client keeps displaying the model of the first virtual character and undisplays the preview model, to achieve an effect that the preview model and the model of the first virtual character are fused.

The client further undisplays the first piece card in the hand region in response to release of the drag operation, to indicate that the first piece card has been used.
4: Modify the level identifier of the first virtual character from the first level identifier to the second level identifier.

In an aspect, a level identifier of a virtual character is configured for indicating a level of the virtual character. The level identifier may be in a form of a value, for example, 1, 2, 3, or 4; may be in a form of a start level, for example, one star, two stars, or three stars; or may be in a form of an icon, different icons representing different levels. A specific form of the level identifier is not limited in this disclosure. The following uses an example in which the level identifier is in the form of a value for description.

In some aspects, the level indicated by the first level identifier is less than the level indicated by the second level identifier.

For example, refer to FIG. 15. In response to release of the drag operation, the client keeps displaying the model of the first virtual character 1503, undisplays the preview model 1502 in the board region and the first piece card 1501 in the hand region, and modifies a level identifier 1504 of the first virtual character 1503 from 2 to 3.

This aspect of this disclosure supports using a card through a drag operation, so that the player object can use the card through a single operation, and does not need to use the card through a plurality of operations. This helps improve convenience of operation. In addition, the level of the deployed first virtual character can be adjusted by using only any first piece card, improving convenience of adjusting the level of the first virtual character.

In an example, after the first piece card is used, the client obtains a level increase of the first virtual character, and modifies the level identifier of the first virtual character from the first level identifier to the second level identifier based on the level increase of the first virtual character. The level increase of the first virtual character may be determined based on quality of the first virtual character and a cost of the first piece card. In some aspects, the level increase of the first virtual character may be determined by the client, or may be determined by a server. This is not limited in this disclosure. The level increase of the first virtual character may be configured for determining the second level identifier.

For example, an example in which the client obtains the level increase of the first virtual character is used for description. In this case, operation 460 may further include the following content.
1: Obtain the quality of the first virtual character and the cost of the first piece card.

In an aspect, quality of a virtual character may be configured for indicating an initial level and level increase efficiency of the virtual character. For example, the quality of the first virtual character may be configured for indicating an initial level and level increase efficiency of the first virtual character. In this aspect, each virtual character corresponds to only one type of quality, and quality of a piece card corresponding to the virtual character is the same as the quality of the virtual character. For example, if the quality of the first virtual character is 1, quality of the first piece card is also 1. Different virtual characters may have different quality. For example, a card that appears later corresponds to higher quality, and a card that appears earlier corresponds to lower quality.

For example, a probability that quality corresponding to a card that appears early is low quality is relatively high, and a probability that quality corresponding to a card that appears late is high quality is relatively high. A specific form of the quality is not limited in this disclosure, and is, for example, a value style, an icon style, or a star level style. Classification of the quality is not limited in this disclosure. For example, the quality may be classified into three types of quality: quality 1, quality 2, and quality 3; or the quality may be classified into five types of quality: quality 1, quality 2, quality 3, quality 4, and quality 5.

The initial level is a level of the virtual character when the virtual character is deployed for the first time (that is, displayed in the board region for the first time). For example, if the level of the first virtual character is 1 when the first virtual character is deployed for the first time, the initial level of the first virtual character is 1. In some aspects, the initial level of the virtual character may be in positive correlation with the quality of the virtual character as a whole. Higher quality of the virtual character indicates a larger initial level of the virtual character. The initial level of the virtual character may alternatively be set by the designer based on the quality of the virtual character. This is not limited in this disclosure.

For example, refer to the following Table 1. For example, three types of quality are provided in this aspect. With a same cost, the initial level of the virtual character is in positive correlation with the quality of the virtual character as a whole.

TABLE 1

| Quality | Cost | Initial level | Level increase |
|---|---|---|---|
| 1 | 1 | 1 | 1 |
| | 2 | 2 | 2 |
| | 3 | 3 | 3 |
| | 4 | 4 | 4 |
| | 5 | 5 | 5 |
| 2 | 1 | 2 | 1 |
| | 2 | 3 | 2 |
| | 3 | 4 | 3 |
| | 4 | 5 | 4 |
| | 5 | 6 | 5 |
| 3 | 1 | 3 | 2 |
| | 2 | 4 | 3 |
| | 3 | 5 | 4 |
| | 4 | 6 | 5 |
| | 5 | 7 | 6 |

The level increase efficiency is configured for indicating a level increase speed of the virtual character. For example, the level increase efficiency of the first virtual character may be configured for indicating a level increase speed of the first virtual character. In some aspects, the level increase efficiency of the virtual character may be in positive correlation with the quality of the virtual character as a whole. Alternatively, the level increase efficiency of the virtual character may be set by the designer based on the quality of the virtual character. This is not limited in this disclosure. For example, higher quality of the virtual character indicates higher level increase efficiency of the virtual character, that is, a higher level increase speed of the virtual character.

In an example, the level increase efficiency may be configured for indicating the level increase speed. For example, the level increase efficiency may be represented by a level increase span, and different quality corresponds to different increase spans. For example, an increase span corresponding to the quality 1 is 1, and an increase span corresponding to the quality 2 is 2.

The cost is energy consumed for using the piece card corresponding to the virtual character. For example, the cost of the first piece card may be energy consumed for using the first piece card. The energy may be represented by an energy value. In some aspects, the level increase efficiency of the first virtual character may also be affected by the cost of the first piece card. For example, a larger level increase indicates higher energy consumption.

In an example, the quality of the first virtual character and the cost of the first piece card may be obtained by querying a character information table. The character information table records related information of each virtual character, for example, an ID, a name, quality, a cost, and a character type. For example, the character information table may be implemented as the following Table 2.

TABLE 2

| ID | Level | Name | Quality | Cost | Character type |
|---|---|---|---|---|---|
| 1000 | 1 | A | 1 | 1 | Wizard |
| 1001 | 2 | B | 1 | 1 | Wizard |
| 1002 | 3 | C | 1 | 1 | Wizard |
| . . . | . . . | . . . | . . . | . . . | . . . |

For example, for a virtual character A, Table 2 may be queried by using an ID or a name of the virtual character A, to obtain that quality of the virtual character A is 1, and a cost of a piece card corresponding to the virtual character A is 1. In this way, the quality and the cost can be quickly obtained through query, improving data obtaining efficiency.
2: Determine the level increase of the first virtual character based on the quality of the first virtual character and the cost of the first piece card.

The level increase is a quantity of levels by which the virtual character needs to be increased. For example, the level increase is a quantity of levels by which the virtual character needs to be increased after a chess player card is used. The level increase may be configured for reflecting the level increase efficiency. For different virtual characters, a larger value of a level increase corresponding to use of one chess player card indicates higher level increase efficiency of the virtual character.

In some aspects, the level increase of the first virtual character is related to the quality of the first virtual character and the cost of the first piece card. On the whole, higher quality of the first virtual character or a higher cost of the first piece card indicates a larger value of the level increase of the first virtual character. Refer to Table 1. When the quality of the first virtual character is fixed, a higher cost of the first piece card indicates a larger value of the level increase of the first virtual character. When the cost of the first piece card is fixed, higher quality of the first virtual character indicates a larger value of the level increase of the first virtual character. In some aspects, the level increase of the first virtual character may alternatively be set by the designer based on the quality of the first virtual character and the cost of the first piece card. This is not limited in this disclosure.

For example, the quality of the first virtual character may be configured for searching a level increase efficiency table to obtain at least one candidate level increase corresponding to the quality of the first virtual character. The level increase efficiency table records a mapping relationship between the quality, the cost, and the level increase. The cost of the first piece card may be configured for determining a target level increase corresponding to the cost of the first piece card from the at least one candidate level increase. The target level increase may be used as the level increase of the first virtual character. In this case, an obtaining process of the level increase may further include the following content.
(1) Search the level increase efficiency table to obtain the at least one candidate level increase corresponding to the quality of the first virtual character.

For example, the level increase efficiency table may be implemented as Table 1. If the quality of the first virtual character is 1, the candidate level increase corresponding to the first virtual character includes 1, 2, 3, 4, and 5.
(2) Determine the target level increase corresponding to the cost of the first piece card from the at least one candidate level increase.

For example, refer to Table 1. If the cost of the first piece card is 2, the target level increase is 2.
(3) Determine the target level increase as the level increase of the first virtual character.

For example, based on the foregoing aspect, if the target level increase is 2, the level increase of the first virtual character is 2.

In this way, the level increase of the first virtual character may be quickly obtained by querying the level increase efficiency table. Because the level increase of the first virtual character is related only to the quality and the cost, complexity of determining the level increase is reduced, helping the player object quickly understand a method for determining the level increase. In addition, the designer may further adjust the level increase by adjusting the quality and the cost, ensuring richness of a control means for the level increase.

In some aspects, the level increase efficiency table is first searched to obtain the at least one candidate level increase corresponding to the cost of the first piece card, and then the target level increase corresponding to the quality of the first virtual character is determined from the at least one candidate level increase. This is not limited in this disclosure.

In some aspects, when a process of determining the level increase of the first virtual character is performed by the server, the server transmits the level increase of the first virtual character to the client after determining the level increase of the first virtual character. In a feasible example, after determining the level increase of the first virtual character, the server may further determine the second level identifier, and indicate the client to modify the level identifier of the first virtual character from the first level identifier to the second level identifier. This is not limited in this disclosure.
3: Modify the level identifier of the first virtual character from the first level identifier to the second level identifier based on the level increase.

In some aspects, the client may determine, based on the level increase and the level indicated by the first level identifier, the level indicated by the second level identifier, to determine the second level identifier. For example, the client sums the level indicated by the first level identifier and the level increase to obtain the level indicated by the second level identifier, further determines the second level identifier based on the level, and then replaces the first level identifier with the second level identifier.

In this way, playing a same-name piece card (that is, the played piece card corresponds to a deployed virtual character) is supported to increase a level of the virtual character. Therefore, after the same-name piece card is played, the level of the corresponding virtual character is immediately increased by a corresponding level increase, and combat power of the virtual character can be instantly increased each time a same-name piece card is played, with no retention period (that is, there is no need to wait for a plurality of same-name piece cards or a plurality of same-name piece cards of a same star level). Therefore, the level of the virtual character can be increased more smoothly, helping improve the gaming experience of the player object.

In an example, to help the player object quickly determine the level increase brought by using the first piece card, when the first virtual character already exists in the board region, the level increase corresponding to the first virtual character may be displayed in the first piece card. For example, refer to FIG. 15. When the first virtual character 1503 already exists in the board region, level information in the first piece card 1501 is configured for indicating that the level of the first virtual character 1503 can be increased by one level by using the first piece card 1501.

In some aspects, when the first virtual character does not exist in the board region, the client displays the initial level of the first virtual character in the first piece card. For example, refer to FIG. 15. For another piece card in the hand region, because there is no corresponding virtual character in the board region, level information in the another piece card is configured for indicating an initial level of the virtual character corresponding to the another piece card when the another piece card is deployed for the first time.

In this way, the player object can quickly obtain an initial level of a virtual character that is deployed for the first time or a level increase of a virtual character that has been deployed. This improves the information obtaining efficiency, facilitates quick decision of the player object, and improves the game experience of the player object.

In an example, the client displays, in response to the operation for using the first piece card, the first virtual character additionally in the board region when the first virtual character does not exist in the board region. The level identifier of the first virtual character is determined based on the initial level of the first virtual character.

In other words, when the first piece card is configured for adding the first virtual character to the board region, the level identifier of the first virtual character is configured for indicating the initial level of the first virtual character, so that the player object can quickly determine the initial level of the first virtual character, improving the information obtaining efficiency.

In some aspects, the initial level of the first virtual character may be determined based on the quality of the first virtual character and the cost of the first piece card. For example, the client may query the level increase efficiency table based on the quality of the first virtual character and the cost of the first piece card, to obtain the initial level of the first virtual character. For example, the level increase efficiency table may be implemented as Table 1. If the quality of the first virtual character is 1, and the cost of the first piece card is 2, the initial level of the first virtual character is 2. If the quality of the first virtual character is 1, and the cost of the first piece card is 1, the initial level of the first virtual character is 1. This is not limited in this disclosure.

In this embodiment of this application, a high-quality piece card (that is, a virtual character) usually appears late. For example, a piece card with the quality 3 appears only in a late phase of the game battle, and a piece card with the quality 1 usually appears in an early phase of the game battle. To maintain a level balance between a virtual character that appears in the early phase and a virtual character that appears in the late phase, in this embodiment of this application, an initial level of a virtual character with high quality is higher than an initial level of a virtual character with low quality, and level increase efficiency of the virtual character with high quality is higher than level increase efficiency of the virtual character with low quality. In this way, a level of the virtual character that appears in the late phase can quickly catch up with a level of the virtual character that appears in the early phase.

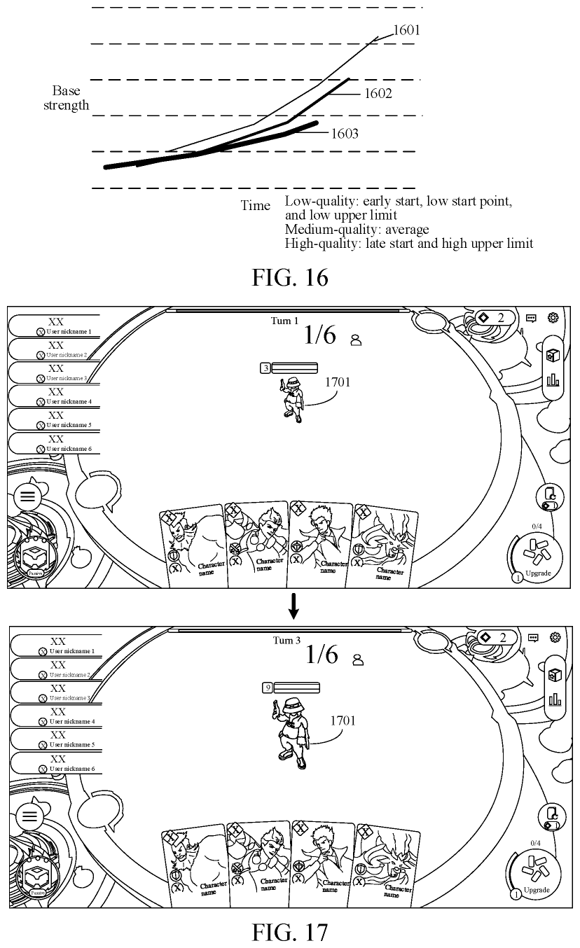

For example, refer to FIG. 16. A curve 1601 is a curve of a change in base strength (that is, equivalent to a level) of a high-quality virtual character over time. A curve 1602 is a curve of a change in base strength (that is, a level) of a medium-quality virtual character over time. A curve 1603 is a curve of a change in base strength (that is, a level) of a low-quality virtual character over time. As can be seen, level increase efficiency of the high-quality virtual character is greater than level increase efficiency of the low-quality virtual character, and an initial level of the high-quality virtual character is greater than an initial level of the low-quality virtual character. High quality may be quality greater than a first quality threshold. Low quality may be quality less than a second quality threshold. Medium quality may be quality less than or equal to the first quality threshold and greater than or equal to the second quality threshold. The first quality threshold is greater than the second quality threshold. The first quality threshold and the second quality threshold may be set and adjusted based on an actual use requirement.

In an example, the level of the virtual character is a standard for measuring base strength of the virtual character. For example, the level of the virtual character represents the base strength (that is, a base attribute) of the virtual character. A higher level of the virtual character indicates stronger base strength of the virtual character. The quality of the virtual character is not directly associated with the base strength of the virtual character. The quality of the virtual character affects only the initial level and the level increase efficiency of the virtual character. Therefore, the base strength of the virtual character can be determined based only on the level of the virtual character, helping simplify a process of determining the base strength of the virtual character.

In some aspects, a mapping relationship between a level and a base strength may be represented by a character level model. The character level model may include base strength of the virtual character at each level and a mapping relationship between a level and base strength corresponding to the level.

However, if a character level model is designed for each virtual character, a large amount of work is brought, and a large amount of data needs to be generated and maintained. Therefore, in this aspect, the virtual characters are classified into a plurality of character types, for example, six, eight, or ten, based on positioning of the virtual characters in the battle. Virtual characters of each character type share a set of level-to-base-attribute templates (that is, a character level model). For example, attribute values of all base attributes of the virtual characters at various levels (for example, levels 1 to 60) are configured in each character level model.

For example, the virtual characters may be classified into six character types, and virtual characters of each character type share a character level model. This implements configuration of base attributes of all the virtual characters at levels 1 to 60 by designing only six character level models, reducing data volumes of the character level models, and further reducing data maintenance costs. In some aspects, a brand new set of exclusive character level models may be separately configured for a few virtual characters. This helps improve flexibility in character level model design. Level division is not limited in this disclosure, and is, for example, levels 1 to 60 or levels 1 to 100.

For example, refer to the following Table 3. The virtual characters may be classified into six character types: a tank, a warrior, a wizard, a shooter, an assassin, and a support. A character level model is correspondingly set for each character type. Each character level model may be identified by a corresponding role level template ID.

TABLE 3

| Virtual character | Character level model ID |
|---|---|
| Tank | 101 |
| Warrior | 102 |
| Wizard | 103 |
| Shooter | 104 |
| Assassin | 105 |
| Support | 106 |

In some aspects, each character level model may be integrated into the following Table 4, to form a level-attribute relationship table.

TABLE 4

| Character | | | Model | Base | Base | Base | |
|---|---|---|---|---|---|---|---|
| level | Character | | scaling | health | attack | spell | Base |
| model ID | type | Level | coefficient | value | power | power | armor |
| 101 | Tank | 1 | 100 | 220 | 40 | 40 | 22 |
| 101 | Tank | 2 | 101 | 245 | 44 | 44 | 22 |
| 101 | Tank | 3 | 102 | 265 | 48 | 48 | 22 |
| . . . | . . . | . . . | . . . | . . . | . . . | . . . | . . . |
| 102 | Warrior | 1 | 100 | 200 | 40 | 0 | 20 |
| 102 | Warrior | 2 | 101 | 220 | 44 | 0 | 20 |
| 102 | Warrior | 3 | 102 | 240 | 48 | 0 | 20 |
| . . . | . . . | . . . | . . . | . . . | . . . | . . . | . . . |
| 103 | Wizard | 1 | 100 | 180 | 40 | 56 | 20 |
| 103 | Wizard | 2 | 101 | 200 | 44 | 62 | 20 |
| 103 | Wizard | 3 | 102 | 220 | 48 | 68 | 20 |
| . . . | . . . | . . . | . . . | . . . | . . . | . . . | . . . |
| 104 | Shooter | 1 | 100 | 180 | 40 | 0 | 20 |
| 104 | Shooter | 2 | 101 | 200 | 44 | 0 | 20 |
| 104 | Shooter | 3 | 102 | 220 | 48 | 0 | 20 |
| . . . | . . . | . . . | . . . | . . . | . . . | . . . | . . . |
| 105 | Assassin | 1 | 100 | 180 | 40 | 12 | 12 |
| 105 | Assassin | 2 | 101 | 200 | 44 | 12 | 12 |
| 105 | Assassin | 3 | 102 | 220 | 48 | 12 | 12 |
| . . . | . . . | . . . | . . . | . . . | . . . | . . . | . . . |
| 106 | Support | 1 | 100 | 100 | 20 | 0 | 15 |
| 106 | Support | 2 | 101 | 110 | 22 | 0 | 15 |
| 106 | Support | 3 | 102 | 120 | 24 | 0 | 15 |
| . . . | . . . | . . . | . . . | . . . | . . . | . . . | . . . |

As can be known from Table 4, for different virtual characters belonging to a same character type, all base attributes at a same level are the same. The base attributes include at least one of the following: the base health value, the base attack power, the base spell power, and the base armor. For virtual characters belonging to different character types, all base attributes at a same level are the same. Different character types correspond to different character level models.

In an example, a process of viewing an attribute value of the first virtual character may include the following content.
1: Obtain a character type of the first virtual character, the character type being a classification attribute of the first virtual character.

In some aspects, the character information table (for example, Table 2) may be queried based on identification information of the first virtual character, to obtain the character type of the first virtual character. For example, Table 2 may be queried based on the name of the virtual character A, to obtain that a character type of the virtual character A is the wizard and a character level model ID is 101.
2: Obtain a character level model corresponding to the character type, the character level model recording a mapping relationship between a level of a virtual character and an attribute value of the virtual character, and the attribute value being configured for indicating strength of the virtual character.

In some aspects, the character level model corresponding to the character type may be obtained from the level-attribute relationship table (for example, Table 4) based on a character level model ID corresponding to the character type. The character level model corresponding to the character type records a mapping relationship between a level of a virtual character of the character type and an attribute value of the virtual character. The attribute value may be an attribute value of a base attribute. A higher attribute value indicates stronger base strength of the virtual character.
3: Obtain, from the character level model corresponding to the character type, an attribute value matching the level of the first virtual character.

For example, if the character level model ID corresponding to the character type is 101, a character level model corresponding to the tank character type may be determined from Table 4. If the level of the first virtual character is 3, attribute values of the base health value, the base attack power, the base spell power, the base armor, and the like that correspond to level 3 in the character level model corresponding to the tank character type are determined as attribute values matching the level of the first virtual character.

In some aspects, the attribute value matching the level of the first virtual character may alternatively be obtained and transmitted by the server to the client. This is not limited in this disclosure.
4: Display, in response to an operation for viewing information about the first virtual character, the attribute value matching the level of the first virtual character.

The operation for viewing the first virtual character may be referred to as a view operation. In some aspects, the view operation may be a trigger operation on the model of the first virtual character in the board region, for example, tapping, double-tapping, or pressing. The view operation may alternatively be a trigger operation on the piece card corresponding to the first virtual character in the hand region. This is not limited in this disclosure.

For example, the client displays an information data card of the first virtual character in response to the view operation on the first virtual character. The information data card includes the attribute value matching the level of the first virtual character, for example, an attribute value of each base attribute of the first virtual character at a current level.

This aspect supports obtaining the character level model corresponding to the character type to quickly obtain the attribute value matching the level of the virtual character, helping improve the information obtaining efficiency and convenience.

In an example, this disclosure further supports adjusting a level of a virtual character by using an effect card, a chess player skill, or a talent of the virtual character. In this way, flexibility in level adjustment of the virtual character can be improved, and virtual character level adjustment methods are enriched. The first virtual character is used as an example. This disclosure may further include at least one of the following content.
1: Modify the second level identifier to a third level identifier in response to an operation for using a first effect card in the hand region, the first effect card being configured for triggering the increase in the level of the first virtual character.

An increase effect of the first effect card is not limited in this disclosure. For example, the first effect card may be configured for increasing the level of the first virtual character by one level, two levels, or three levels.

In some aspects, a card playing operation on the first effect card may be dragging the first effect card to the first virtual character located in the board region, to increase the level of the first virtual character. The card playing operation on the first effect card may include a first tap operation and a second tap operation. For example, the first effect card may be selected through the first tap operation on the first effect card, and the first virtual character may be used as an acting target of the first effect card through the second tap operation on the first virtual character. This is not limited in this disclosure. In some aspects, when the acting target of the first effect card is all deployed virtual characters, only the first effect card needs to be triggered, and the acting target does not need to be selected. For example, levels of all the deployed virtual characters (including the first virtual character) may be increased by dragging the first effect card to any location in the board region.

A level indicated by the third level identifier is different from the level indicated by the second level identifier and the level indicated by the first level identifier. For example, the level indicated by the third level identifier is greater than the level indicated by the second level identifier and the level indicated by the first level identifier.
2: Modify the second level identifier to a third level identifier in response to a turn count of the turn-based board game reaching a first threshold corresponding to the first virtual character.

The first threshold corresponding to the first virtual character may be configured for indicating whether to trigger a talent skill (that is, an effect generated by a talent) of the first virtual character. In some aspects, the first threshold may be determined based on the talent of the first virtual character. If the talent of the first virtual character additionally increases the level of the first virtual character by two levels when the turn count is 4, the first threshold corresponding to the first virtual character is 4.

The talent of the first virtual character is not limited in this disclosure. The talent may be related to the level, an attribute, a quantity of used cards, and the like of the first virtual character. For example, when the first virtual character is upgraded to level 20, the level of the first virtual character is additionally increased by two levels. For another example, when the quantity of used cards reaches 20, the level of the first virtual character is additionally increased by two levels.
3: Modify the second level identifier to a third level identifier in response to an operation for using a chess player skill of a chess player character, the chess player character being a character played by a user and configured for controlling a virtual character.

The operation for using the chess player skill of the chess player character may be referred to as a trigger operation. The chess player skill may be a skill configured for triggering an increase in a level of the virtual character. For example, a skill effect of a chess player character is specifying a level of an own piece in the board region to be increased by 2 each time three cards are played, specifying a level of an own piece in the board region to be increased by 2 each time 10 energy points are consumed, or additionally increasing the level of the virtual character by two levels when the virtual character is upgraded to level 20. This is not limited in this disclosure.

In an example, as levels are increased, a part of virtual characters may further obtain special effects (corresponding to the foregoing additional effect) at specified levels, helping improve the game experience of the player object. In this case, this aspect may further include the following content: triggering a bonus event when the level indicated by the second level identifier reaches a level threshold, the bonus event including at least one of the following: additionally providing a specified quantity of cards, additionally providing a specified amount of energy, increasing the level of the virtual character in the board region, increasing the attribute value of the virtual character in the board region, and recovering a virtual health value of the chess player character.

The level threshold may be set and adjusted based on an actual use requirement, and is, for example, level 20, level 30, or level 40. The bonus event is an event generated by a special effect.

For example, when the level of the first virtual character reaches level 20, the client triggers the bonus event of “additionally providing two cards”, that is, the client additionally provides two cards to the player object.

In an example, the model of the virtual character may further change as the level rises, helping the player object obtain a level difference of the virtual character more conveniently, to improve the information obtaining efficiency and convenience. This aspect may further include at least one of the following content.
1: A size of the first virtual character under the second level identifier is greater than a size of the first virtual character under the first level identifier.

The size may be a size of the model of the first virtual character. In some aspects, a higher level of the first virtual character indicates a larger size of the first virtual character.

For example, the first virtual character corresponds to one model scaling coefficient at each level, and the model scaling coefficient is configured for scaling the size of the model of the first virtual character. For example, refer to Table 4. A size of the first virtual character at level 1 is a base size, and a model scaling coefficient is 100. A size of the first virtual character at level 2 is a product of the base size and a model scaling coefficient (101). A size of the first virtual character at level 3 is a product of the base size and a model scaling coefficient (102).

For example, refer to FIG. 17. A size of a model of a first virtual character 1701 at level 9 is greater than a size of the model of the first virtual character 1701 at level 3.
2: An appearance of the first virtual character under the second level identifier is different from an appearance of the first virtual character under the first level identifier.

In some aspects, the difference in appearance may refer to a difference in the clothes of the virtual character, a difference in the ornaments of the virtual character, or a difference in the models of the virtual character. This is not limited in this disclosure.

For example, clothes of the first virtual character at level 9 are different from clothes of the first virtual character at level 3.
3: A skill effect of the first virtual character under the second level identifier is different from a skill effect of the first virtual character under the first level identifier.

In some aspects, the difference in skill effects may refer to a difference in ranges or styles of the skill. This is not limited in this disclosure. For example, a skill effect range of the first virtual character at level 9 is greater than a skill effect range of the first virtual character at level 3.

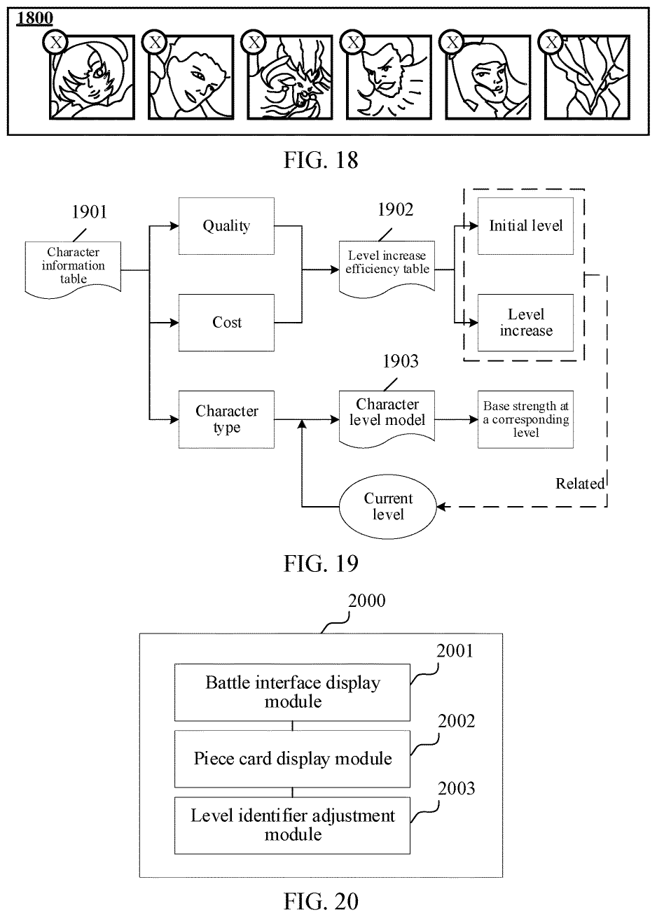

In an example, the battle interface further includes a lineup region. The lineup region is configured for displaying a virtual character lineup. For example, an image of each deployed virtual character, for example, an avatar, a bust, or a full-length image of the virtual character, is displayed in the lineup region. For example, refer to FIG. 18. Avatars of six deployed virtual characters are displayed in a lineup region 1800, and current levels of the virtual characters are displayed at top-left corners of the avatars. This helps the player object quickly learn a lineup match of the player object and a current level of each virtual character, so that the player object can quickly make a decision, improving the game experience of the player object.

According to the technical solution provided in this aspect, when the first virtual character already exists in the board region corresponding to the turn-based board game, each first piece card corresponding to the first virtual character may be configured for adjusting the level of the first virtual character, so that the user can adjust the level of the first virtual character only by using any first piece card, without collecting a plurality of first piece cards that satisfy a preset condition and that correspond to the first virtual character, improving convenience of adjusting the level of the first virtual character. In addition, time consumed in accumulating piece cards is shortened, so that level stagnation duration of the first virtual character is shortened, helping improve coherence of level adjustment of the first virtual character.

In addition, compared with related art in which operations need to be performed on the plurality of first piece cards, the level of the first virtual character can be adjusted through only one operation. This helps improve human-computer interaction efficiency and further improve the convenience of adjusting the level of the first virtual character. In addition, use of a same-name piece card is supported to increase the level of the virtual character without collecting the piece cards satisfying the preset condition. This reduces difficulty in adjusting the level of the virtual character, lowering an entry barrier for the turn-based board game and helping improve user stickiness. In addition, the user can flexibly adjust, based on a requirement, the level of the virtual character by using a same-name piece card, without a limitation of the preset condition. This helps improve flexibility of human-computer interaction, further improving the user stickiness.

In some aspects, an example in which the turn-based board game is an auto chess game is used to describe the base strength of the virtual character.

The virtual character has different base strength at different levels. For different levels, the base strength may be determined based on base attributes at the levels. For example, the base strength may be a weighted sum of attribute values of the base attributes.

In related art, an upper limit of a star level increase of the virtual character is three stars, and there is a retention period for an increase in a start level of each virtual character. Therefore, a variance in lineup strength is not so significant no matter whether an early lineup or a late lineup is selected (as can be seen from a real battle that lineups of most player objects in a final circle each include a small quantity of three-star virtual characters and a large quantity of two-star virtual characters).

However, in this aspect, the base strength of the virtual character is split and allocated across 60 levels. Each time a same-name piece card, an upgrade-related effect card, or the like is played, the base strength of the virtual character is improved once. If the level increase efficiency is not differentiated, a level of a high-quality virtual character obtained only in the late phase may fall far behind a level of a low-quality virtual character cultivated from the early phase.

Therefore, in this aspect, the high-quality virtual character and the low-quality virtual character are provided with different growth rates. The level increase efficiency in this aspect may be affected by both the quality of the virtual character and the cost of the piece card. For example, the high-quality virtual character has a higher initial level, and cost efficiency (that is, a ratio of the cost to the level increase efficiency) of the high-quality virtual character is higher. In other words, a rule that higher quality indicates greater X is added to a basic template that one cost point increases the level by fixed X points. With reference to the two designs, although the low-quality virtual character is obtained earlier in the early phase, a window period of a level increase corresponding to the low-quality virtual character is longer, and efficiency is relatively low. However, although the high-quality virtual character is obtained later, an initial level and a level increase corresponding to the high-quality virtual character are higher, and a window period of the level increase is shorter. Therefore, levels of early and late virtual characters can be balanced.

For example, refer to FIG. 19. For a deployed virtual character in the board region, a method for calculating a current level of the deployed virtual character may be as follows.
1: Search a character information table 1901 based on a name of the deployed virtual character, to obtain quality of the deployed virtual character and a corresponding cost.
2: Search, based on the quality of the deployed virtual character and the corresponding cost, a level increase efficiency table 1902 to obtain a corresponding initial level X1 and a level increase X2 corresponding to use of a same-name piece card.
3: Obtain a quantity N of same-name piece cards (excluding a piece card configured for adding the deployed virtual character to the board region) corresponding to the deployed virtual character.
4: Obtain an effect card used for increasing a level of the deployed virtual character, and determine, based on an actual effect configured for the effect card, a level increase X3 brought by the effect card.
5: Level increase X4 brought in another manner (for example, a chess player skill or a talent).

Then, a current level of the deployed virtual character may be represented as: X=X1+X2*N+X3+X4.

In some aspects, after the current level of the deployed virtual character is obtained, a character level model 1903 corresponding to the deployed virtual character may be determined based on a character type of the deployed virtual character, and then current base strength of the deployed virtual character is determined from the character level model 1903 based on the current level X of the deployed virtual character.

In this aspect, only the level of the virtual character is used as a measurement standard of the base strength of the virtual character, to facilitate understanding by the player object. In addition, the designer only needs to extend the base strength of the virtual character for the level of the virtual character, difficulty in extending the base strength is low, and an upper limit for extension of the base strength is high.

In addition, from a numerical perspective, replacing the star level increase in related art with the level increase in this aspect changes a numerical growth curve from original jump growth of the base strength across one-star, two-star, and three-star tiers to a smoother increase, reducing a variance caused by luck in the battle. In addition, regardless of the quality and the cost corresponding to the virtual character, a plurality of virtual characters of a same character type at a same level have the same base strength. However, because level increase efficiency of virtual characters with different quality is different, differences in base strength may be brought.

The following is an example of an apparatus, and the apparatus may be configured to implement the methods included in this disclosure. For details not disclosed in the apparatus, refer to the methods included in this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 20 is a block diagram of a virtual character level adjustment apparatus according to an aspect of this disclosure. The apparatus has a function of implementing the examples of the method. The function may be implemented by hardware, or may be implemented by hardware executing corresponding software. The apparatus may be the terminal described above, or may be disposed on the terminal. The apparatus 2000 includes a battle interface display module 2001, a piece card display module 2002, and a level identifier adjustment module 2003.

The battle interface display module 2001 is configured to display a battle interface of a turn-based board game, the battle interface including a hand region and a board region, the hand region being configured for displaying a card, and the board region being configured for displaying a virtual character.

The piece card display module 2002 is configured to display a first piece card in the hand region, the first piece card being configured for adding a first virtual character to the board region or adjusting a level of a first virtual character already existing in the board region.

The level identifier adjustment module 2003 is configured to modify, in response to an operation for using the first piece card, a level identifier of the first virtual character displayed in the board region from a first level identifier to a second level identifier when the first virtual character already exists in the board region, a level indicated by the first level identifier being different from a level indicated by the second level identifier.

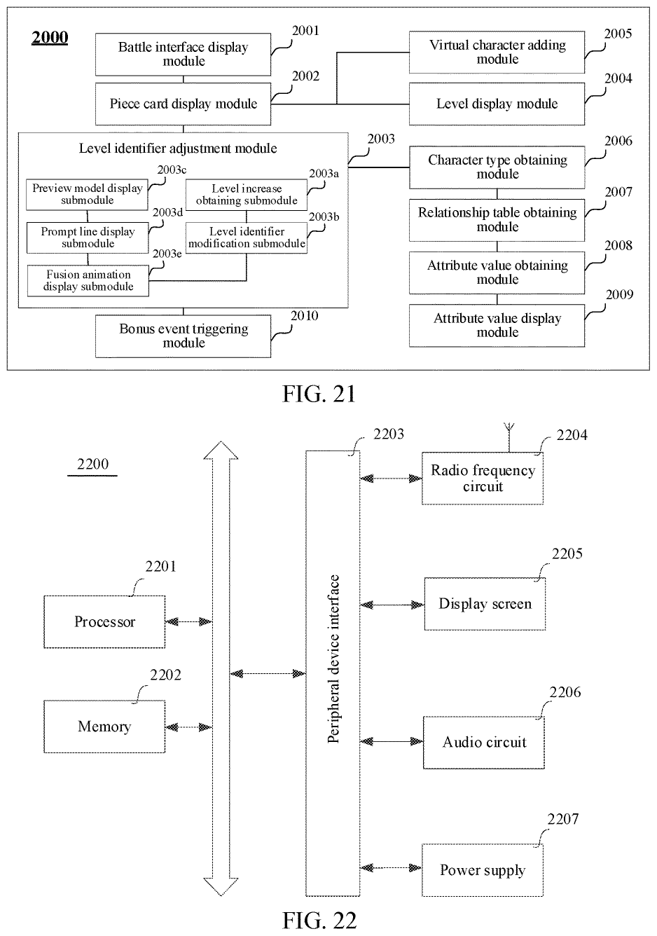

In some aspects, as shown in FIG. 21, the level identifier adjustment module 2003 includes a level increase obtaining submodule 2003a and a level identifier modification submodule 2003b.

The level increase obtaining submodule 2003a is configured to obtain a level increase of the first virtual character, the level increase being determined based on quality of the first virtual character and a cost of the first piece card, the quality being configured for indicating an initial level and level increase efficiency of the first virtual character, the level increase efficiency being configured for indicating a level increase speed of the first virtual character, and the cost being energy consumed by using a piece card corresponding to the first virtual character.

The level identifier modification submodule 2003b is configured to modify the level identifier of the first virtual character from the first level identifier to the second level identifier based on the level increase.

In some aspects, the quality of the first virtual character is configured for searching a level increase efficiency table to obtain at least one candidate level increase corresponding to the quality of the first virtual character, the level increase efficiency table recording a mapping relationship between the quality, the cost, and the level increase. The cost of the first piece card is configured for determining a target level increase corresponding to the cost of the first piece card from the at least one candidate level increase, the target level increase being used as the level increase of the first virtual character.

In some aspects, as shown in FIG. 21, the apparatus 2000 further includes a level display module 2004.

The level display module 2004 is configured to display the level increase of the first virtual character in the first piece card when the first virtual character already exists in the board region. Alternatively, the level display module 2004 is further configured to display the initial level of the first virtual character in the first piece card when the first virtual character does not exist in the board region.

In some aspects, as shown in FIG. 21, the apparatus 2000 further includes a virtual character adding module 2005.

The virtual character adding module 2005 is configured to display, in response to the operation for using the first piece card, the first virtual character additionally in the board region when the first virtual character does not exist in the board region, the level identifier of the first virtual character being determined based on the initial level of the first virtual character.

In some aspects, as shown in FIG. 21, the apparatus 2000 further includes a character type obtaining module 2006, a relationship table obtaining module 2007, an attribute value obtaining module 2008, and an attribute value display module 2009.

The character type obtaining module 2006 is configured to obtain a character type of the first virtual character, the character type being a classification attribute of the first virtual character.

The relationship table obtaining module 2007 is configured to obtain a character level model of the character type, the character level model recording a mapping relationship between a level of a virtual character and an attribute value of the virtual character, and the attribute value being configured for indicating strength of the virtual character.

The attribute value obtaining module 2008 is configured to obtain, from the character level model corresponding to the character type, an attribute value matching the level of the first virtual character.

The attribute value display module 2009 is configured to display, in response to an operation for viewing information about the first virtual character, the attribute value matching the level of the first virtual character.

In some aspects, the level identifier adjustment module 2003 is further configured to
modify the second level identifier to a third level identifier in response to an operation for using a first effect card in the hand region, the first effect card being configured for triggering an increase in the level of the first virtual character; modify the second level identifier to a third level identifier in response to a turn count of the turn-based board game reaching a first threshold corresponding to the first virtual character; or modify the second level identifier to a third level identifier in response to an operation for using a chess player skill of a chess player character, the chess player character being a character played by a user and configured for controlling a virtual character, and a level indicated by the third level identifier being different from the level indicated by the second level identifier and the level indicated by the first level identifier.

In some aspects, as shown in FIG. 21, the apparatus 2000 further includes a bonus event triggering module 2010.

The bonus event triggering module 2010 is configured to trigger a bonus event when the level indicated by the second level identifier reaches a level threshold, the bonus event including at least one of the following: additionally providing a specified quantity of cards, additionally providing a specified amount of energy, increasing a level of the virtual character in the board region, increasing an attribute value of the virtual character in the board region, and recovering a virtual health value of the chess player character.

In some aspects, a size of the first virtual character under the second level identifier is greater than a size of the first virtual character under the first level identifier. Alternatively, an appearance of the first virtual character under the second level identifier is different from an appearance of the first virtual character under the first level identifier. Alternatively, a skill effect of the first virtual character under the second level identifier is different from a skill effect of the first virtual character under the first level identifier.

In some aspects, as shown in FIG. 21, the level identifier adjustment module 2003 further includes a preview model display submodule 2003c, a prompt line display submodule 2003d, and a fusion animation display submodule 2003e.

The preview model display submodule 2003c is configured to display a preview model of the first virtual character corresponding to the first piece card in the board region in response to a drag operation for dragging the first piece card from the hand region to the board region.

The prompt line display submodule 2003d is configured to display a first prompt line between the preview model and a model of the first virtual character when the first virtual character already exists in the board region, the first prompt line being configured for prompting triggering of the increase in the level of the first virtual character by the first piece card.

The fusion animation display submodule 2003e is configured to display, in response to release of the drag operation, a picture in which the preview model and the model of the first virtual character are fused.

The level identifier modification submodule 2003b is further configured to modify the level identifier of the first virtual character from the first level identifier to the second level identifier.

According to the technical solution provided in this aspect of this disclosure, when the first virtual character already exists in the board region corresponding to the turn-based board game, each first piece card corresponding to the first virtual character may be configured for adjusting the level of the first virtual character, so that the user can adjust the level of the first virtual character only by using any first piece card, without collecting a plurality of first piece cards that satisfy a preset condition and that correspond to the first virtual character, improving convenience of adjusting the level of the first virtual character. In addition, time consumed in accumulating piece cards is shortened, so that level stagnation duration of the first virtual character is shortened, helping improve coherence of level adjustment of the first virtual character. In addition, compared with related art in which operations need to be performed on the plurality of first piece cards, the level of the first virtual character can be adjusted through only one operation. This helps improve human-computer interaction efficiency and further improve the convenience of adjusting the level of the first virtual character.

When a function of the apparatus provided in the foregoing aspect is implemented, division into the foregoing functional modules is used as an example for description. In an actual application, the foregoing functions may be allocated to and completed by different functional modules as required. In other words, an internal structure of the apparatus is divided into different functional modules to complete all or a part of the functions described above. In addition, the apparatus provided in the foregoing aspect falls within a same concept as the method aspect. For details of a specific implementation process of the apparatus, refer to the method aspect. Details are not described herein again.

FIG. 22 is a block diagram of a structure of a terminal device according to an aspect of this disclosure. The terminal device 2200 is configured to implement the virtual character level adjustment method provided in the foregoing aspects. The terminal device 2200 may be a terminal (for example, the first terminal 110 or the second terminal 130) in the implementation environment shown in FIG. 1. Details are as follows.

In an example, the terminal device 2200 includes a processor 2201 and a memory 2202.

In some aspects, the processor 2201 may include one or more processing cores, such as a four-core processor or an eight-core processor. The processor 2201 may be implemented in at least one hardware form of a digital signal processor (DSP), a field programmable gate array (FPGA), and a programmable logic array (PLA). The processor 2201 may alternatively include a main processor and a coprocessor. The main processor is a processor configured to process data in an awake state, and is also referred to as a central processing unit (CPU). The coprocessor is a low power consumption processor configured to process data in a standby state. In some aspects, the processor 2201 may be integrated with a graphics processing unit (GPU), and the GPU is configured to render and draw content that needs to be displayed on a display screen. In some aspects, the processor 2201 may alternatively include an artificial intelligence (AI) processor. The AI processor is configured to process computing operations related to machine learning.

In some aspects, the memory 2202 may include one or more computer-readable storage media. The computer-readable storage medium may be non-transitory. The memory 2202 may further include a high-speed random access memory and a non-volatile memory, for example, one or more disk storage devices and flash storage devices. In some aspects, the non-transitory computer-readable storage medium in the memory 2202 is configured to store a computer program. The computer program is configured for being executed by one or more processors, to implement the virtual character level adjustment method.

In some aspects, the terminal device 2200 may further include a peripheral device interface 2203 and at least one peripheral device. The processor 2201, the memory 2202, and the peripheral device interface 2203 may be connected to each other through a bus or a signal cable. Each peripheral device may be connected to the peripheral device interface 2203 through a bus, a signal cable, or a circuit board. In some examples, the peripheral device includes at least one of a radio frequency circuit 2204, a display screen 2205, an audio circuit 2206, and a power supply 2207.

In an example, the structure shown in FIG. 22 constitutes no limitation on the terminal device 2200, and the terminal device 2200 may include more or fewer components than those shown in the figure, or some components may be combined, or a different component deployment may be used.

In some aspects, a computer-readable storage medium is further provided. The storage medium has a computer program stored therein. When the computer program is executed by a processor, the foregoing virtual character level adjustment method is implemented.

In some aspects, the computer-readable storage medium may include a read-only memory (ROM), a random access memory (RAM), a solid state drive (SSD), an optical disc, or the like. The random access memory may include a resistive random access memory (ReRAM) and a dynamic random access memory (DRAM).

In some aspects, a computer program product is further provided. The computer program product includes a computer program. The computer program is stored in a computer-readable storage medium. A processor of a terminal device reads the computer program from the computer-readable storage medium. The processor executes the computer program, so that the terminal device performs the foregoing virtual character level adjustment method.

In the aspects of this disclosure, before and during collection of relevant data of a user, a prompt interface or a pop-up window may be displayed, or voice prompt information may be outputted. The prompt interface, the pop-up window, or the voice prompt information is configured for prompting the user that the relevant data of the user is currently collected. In this way, after a confirmation operation of the user for the prompt interface or the pop-up window is obtained, relevant operations of obtaining the relevant data of the user start to be performed. Otherwise (in other words, when a confirmation operation of the user for the prompt interface or the pop-up window is not obtained), relevant operations of obtaining the relevant data of the user are ended, that is, the relevant data of the user is not obtained.

The foregoing descriptions are non-limiting aspects of this disclosure, and are not intended to limit this disclosure. Any modification, equivalent replacement, or improvement of this disclosure shall fall within the scope of this disclosure.

What is claimed is:

1. A virtual character level adjustment method, comprising:
displaying a battle interface of a turn-based board game, the battle interface including a hand region and a board region;
displaying a piece card in the hand region, the piece card being used to generate a virtual character in the board region when the virtual character is not in the board region or adjust a level of the virtual character when the virtual character is in the board region; and
modifying, in response to an operation on the piece card, a level identifier of the virtual character in the board region from a first level identifier to a second level identifier based on level information of the virtual character and an energy value of the piece card, the level information indicating an initial level and a level progression rate of the virtual character, and the energy value indicating a quantity of energy required to use the piece card.

2. The method according to claim 1, wherein the modifying comprises:
obtaining a level increase of the virtual character based on the level progression rate of the virtual character and the energy value of the piece card; and
modifying the level identifier of the virtual character from the first level identifier to the second level identifier based on the level increase, a level indicated by the first level identifier being different from a level indicated by the second level identifier.

3. The method according to claim 2, wherein the obtaining the level increase comprises:
searching a level progression rate table to obtain at least one candidate level increase based on the level information of the virtual character, the level progression rate table indicating a mapping relationship of the level information, the energy value, and the level increase; and
determining the level increase from the at least one candidate level increase based on the energy value of the piece card.

4. The method according to claim 2, further comprising:
displaying the level increase of the virtual character in the piece card when the virtual character is in the board region; and
displaying the initial level of the virtual character in the piece card when the virtual character is not in the board region.

5. The method according to claim 1, further comprising:
generating, in response to the operation on the piece card, the virtual character in the board region when the virtual character is not in the board region.

6. The method according to claim 1, further comprising:
obtaining a character type of the virtual character, the character type being a classification attribute of the virtual character;
obtaining a character level model of the character type, the character level model indicating a mapping relationship between the level of the virtual character and an attribute value of the virtual character indicating a strength of the virtual character;
obtaining, from the character level model of the character type, the attribute value matching the level of the virtual character; and
displaying the attribute value matching the level of the virtual character.

7. The method according to claim 6, further comprising:
modifying the second level identifier to a third level identifier in response to an operation on an effect card in the hand region, the effect card being used to trigger an increase in the level of the virtual character;
modifying the second level identifier to the third level identifier in response to a turn count of the turn-based board game reaching a threshold corresponding to the virtual character; and
modifying the second level identifier to the third level identifier in response to an operation on a chess player skill of a chess player character that is used to control the virtual character, and a level indicated by the third level identifier being different from a level indicated by the second level identifier and a level indicated by the first level identifier.

8. The method according to claim 7, further comprising:
triggering a bonus event when the level indicated by the second level identifier reaches a level threshold, the bonus event including at least one of: providing an additional card, providing an additional amount of energy, increasing the level of the virtual character in the board region, increasing the attribute value of the virtual character in the board region, or recovering a virtual health value of the chess player character.

9. The method according to claim 1, wherein a size of the virtual character with the second level identifier is greater than a size of the virtual character with the first level identifier; an appearance of the virtual character with the second level identifier is different from an appearance of the virtual character with the first level identifier; or a skill effect of the virtual character with the second level identifier is different from a skill effect of the virtual character with the first level identifier.

10. The method according to claim 7, wherein the modifying comprises:
displaying a preview model of the virtual character corresponding to the piece card in the board region in response to a drag operation through which the piece card is dragged from the hand region to the board region;
displaying a prompt line between the preview model and a model of the virtual character when the virtual character is in the board region, the prompt line being used to prompt triggering of the increase in the level of the virtual character by the piece card;
displaying, in response to a release of the drag operation, a picture in which the preview model and the model of the virtual character are fused; and
modifying the level identifier of the virtual character from the first level identifier to the second level identifier.

11. An apparatus, comprising processing circuitry configured to:
display a battle interface of a turn-based board game, the battle interface including a hand region and a board region;
display a piece card in the hand region, the piece card being used to generate a virtual character in the board region when the virtual character is not in the board region or adjust a level of the virtual character when the virtual character is in the board region; and
modify, in response to an operation on the piece card, a level identifier of the virtual character in the board region from a first level identifier to a second level identifier based on level information of the virtual character and an energy value of the piece card, the level information indicating an initial level and a level progression rate of the virtual character, and the energy value indicating a quantity of energy required to use the piece card.

12. The apparatus according to claim 11, wherein the processing circuitry is configured to:
obtain a level increase of the virtual character based on the level information of the virtual character and the energy value of the piece card; and
modify the level identifier of the virtual character from the first level identifier to the second level identifier based on the level increase, a level indicated by the first level identifier being different from a level indicated by the second level identifier.

13. The apparatus according to claim 12, wherein the processing circuitry is configured to:
search a level progression rate table to obtain at least one candidate level increase based on the level information of the virtual character, the level progression rate table indicating a mapping relationship of the level information, the energy value, and the level increase; and
determine the level increase from the at least one candidate level increase based on the energy value of the piece card.

14. The apparatus according to claim 12, wherein the processing circuitry is configured to:
display the level increase of the virtual character in the piece card when the virtual character is in the board region; and
display the initial level of the virtual character in the piece card when the virtual character is not in the board region.

15. The apparatus according to claim 11, wherein the processing circuitry is configured to:
generate, in response to the operation on the piece card, the virtual character in the board region when the virtual character is not in the board region.

16. The apparatus according to claim 11, wherein the processing circuitry is configured to:
obtain a character type of the virtual character, the character type being a classification attribute of the virtual character;
obtain a character level model of the character type, the character level model indicating a mapping relationship between the level of the virtual character and an attribute value of the virtual character, and the attribute value indicating a strength of the virtual character;
obtain, from the character level model of the character type, the attribute value matching the level of the virtual character; and
display the attribute value matching the level of the virtual character.

17. The apparatus according to claim 16, wherein the processing circuitry is configured to:
modify the second level identifier to a third level identifier in response to an operation on an effect card in the hand region, the effect card being used to trigger an increase in the level of the virtual character;
modify the second level identifier to the third level identifier in response to a turn count of the turn-based board game reaching a threshold corresponding to the virtual character; or
modify the second level identifier to the third level identifier in response to an operation on a chess player skill of a chess player character that is used to control the virtual character, and a level indicated by the third level identifier being different from a level indicated by the second level identifier and a level indicated by the first level identifier.

18. The apparatus according to claim 17, wherein the processing circuitry is configured to:
trigger a bonus event when the level indicated by the second level identifier reaches a level threshold, the bonus event including at least one of: providing an additional card, providing an additional amount of energy, increasing the level of the virtual character in the board region, increasing the attribute value of the virtual character in the board region, or recovering a virtual health value of the chess player character.

19. The apparatus according to claim 11, wherein a size of the virtual character with the second level identifier is greater than a size of the virtual character with the first level identifier; an appearance of the virtual character with the second level identifier is different from an appearance of the virtual character with the first level identifier; or a skill effect of the virtual character with the second level identifier is different from a skill effect of the virtual character with the first level identifier.

20. A non-transitory computer-readable storage medium storing instructions, which when executed by a processor, cause the processor to implement a virtual character level adjustment method, the method comprising:
displaying a battle interface of a turn-based board game, the battle interface including a hand region and a board region;
displaying a piece card in the hand region, the piece card being used to generate a virtual character in the board region when the virtual character is not in the board region or adjust a level of the virtual character when the virtual character is in the board region; and
modifying, in response to an operation on the piece card, a level identifier of the virtual character in the board region from a first level identifier to a second level identifier based on level information of the virtual character and an energy value of the piece card, the level information indicating an initial level and a level progression rate of the virtual character, and the energy value indicating a quantity of energy required to use the piece card.
